(19) United States
(12) Patent Application Publication
(10) Pub. No.: US 2026/0166458 A1
(43) Pub. Date: Jun. 18, 2026

(54) Filter component for a handheld work apparatus

(71) Applicant: Andreas Stihl AG & Co. KG, Waiblingen (DE)

(72) Inventors: Florian Tessaro, Altbach (DE); Roland Mandel, Stuttgart (DE); Martin Failenschmid, Engstingen (DE); Daniel Pastor, Weissach im Tal (DE); David Stäbler, Ostfildern (DE); Nicolas Wienand, Weissach im Tal (DE); Heiko DIEHL, Esslingen (DE); Daniel Böpple, Stuttgart (DE); Daniel MARTIN, Winnenden (DE); Hans-Martin Hascher, Laichingen (DE); Martin Strobel, Baltmannsweiler (DE); Felix Grauf, Leinfelden-Echterdingen (DE)

(73) Assignee: Andreas Stihl AG & Co. KG, Waiblingen (DE)

(21) Appl. No.: 19/417,100

(22) Filed: Dec. 11, 2025

(30) Foreign Application Priority Data
Dec. 12, 2024 (DE) 102024137498.5
Dec. 12, 2024 (DE) 102024137499.3
Dec. 12, 2024 (DE) 102024137500.0
Dec. 12, 2024 (DE) 102024137501.9

(51) Int. Cl. B01D 39/10; B01D 46/00; B27B 17/00

(52) U.S. Cl. CPC B01D 39/10; B01D 46/0005; B27B 17/00

(57) ABSTRACT

A handheld work apparatus includes a filter component (1) for filtering cooling air. The filter component (1) is provided to form a part of an outer side (3) of the work apparatus (2). The filter component (1) has thick thread elements (4) and thin thread elements (5). The cooling air has to pass through both the thin thread elements (5) as well as the thick thread elements (4) for the purpose of filtering the cooling air. The thick thread elements (4) and the thin elements (5) are each thread-like. The diameter (d1) of the thick thread elements (4) is greater than the diameter (d2) of the thin thread elements (5). The thick thread elements (4) serve to support the thin thread elements (5).

### CROSS-REFERENCE TO RELATED APPLICATION

This application claims the benefit of German Patent Applications DE 102024137500.0, DE 102024137498.5, DE 102024137501.9, and DE 102024137499.3, each filed on Dec. 12, 2024. The disclosures of these applications are hereby incorporated by reference in their entireties.

### TECHNICAL FIELD

The disclosure relates to a filter component for filtering cooling air for a handheld work apparatus.

### BACKGROUND

An outer filter component of such type is known from EP 3 798 433 A1.

### SUMMARY

The present invention is based on the object of further developing a filter component of the generic type in such a way that it simultaneously has a good filtering effect and a great mechanical resistance against external forces acting on the filter component.

This object is solved by a filter component for filtering cooling air for a handheld work apparatus, wherein the filter component is provided to form a part of an outer side of the work apparatus, wherein the filter component has thick thread elements and thin thread elements, wherein the cooling air has to pass through both the thin thread elements as well as the thick thread elements for the purpose of filtering the cooling air, wherein the thick thread elements and the thin thread elements are each strand-shaped, wherein the diameter of the thick thread elements is greater than the diameter of the thin thread elements, and wherein the thick thread elements serve to support the thin thread elements.

A further object of the invention is to further develop a generic handheld work apparatus having a filter component in such a way that simultaneously a good filtering effect and a great mechanical resistance against external forces acting on the filter component is enabled.

This object is solved by a handheld work apparatus having a filter component, wherein the filter component is provided to form a part of an outer side of the work apparatus, wherein the filter component has thick thread elements and thin thread elements, wherein the cooling air has to pass through both the thin thread elements as well as the thick thread elements for the purpose of filtering the cooling air, wherein the thick thread elements and the thin thread elements are each thread-like, wherein the diameter of the thick thread elements is greater than the diameter of the thin thread elements, wherein the thick thread elements serve to support the thin thread elements, wherein the filter component forms a part of an outer side of the work apparatus, and wherein cooling air can flow through the filter component from the outside into an inner region of the work apparatus in a through-flow direction.

The invention is based on the knowledge that a good filtering effect is achieved by a fine filter structure made from relatively fine components having a relatively little strength and that great mechanical resistance is achieved by a coarse filter structure having components with greater strength. Both advantages can be achieved simultaneously by the fact that the filter component according to the invention has thick thread elements and thin thread elements. The cooling air has to pass through both the thin thread elements as well as the thick thread elements for the purpose of filtering the cooling air. The thick thread elements and the thin elements are each thread-like. The diameter of the thick thread elements is greater than the diameter of the thin thread elements. The thick thread elements serve to support the thin thread elements.

A very good filtering effect can be achieved by the thin thread elements. The mesh size of the filter component can be small due to the thin thread elements. The thick thread elements simultaneously support the thin thread elements and ensure great mechanical resistance of the filter component.

Thread elements are in particular elongated, strand-shaped (thread-like) components. In particular, a thread element extends along a longitudinal direction. The longitudinal direction does not have to run linearly but can follow a curve shape. Cross-sections through thread elements in the direction perpendicular to the longitudinal direction have a diameter which corresponds to the largest extent of the cross-section. In particular, the cross-sections are substantially circular.

In, particular, it can be provided that the thick thread elements are in their own right interwoven, in particular interlaced, to form a supporting fabric and the thin thread elements are in their own right interwoven, in particular interlaced, to form a filter fabric. In this case, the filter component comprises two layers. The thick thread elements form a first layer, specifically the supporting fabric, and the thin thread elements form a second layer, specifically the filter fabric. In particular, the supporting fabric is a woven fabric. Woven fabrics are created by weaving two intersecting threads: warp and weft threads. However, it can also be provided that the supporting fabric is a knitted fabric. Knitted fabrics are produced by forming stitches on a knitting machine. In the process, thread loops are interlaced in order to create a surface. In particular, the filter fabric is a woven fabric. However, it can also be provided that the filter fabric is a knitted fabric. In particular, the thick thread elements in their own right form a woven fabric, in particular a knitted fabric. In particular, the thin thread elements in their own right form a woven fabric, in particular a knitted fabric. Alternatively, it can be provided that the thick thread elements and the thin elements are interwoven, in particular interlaced, to form a single supporting filter fabric. In particular, the supporting filter fabric is a woven fabric. However, it can also be provided that the supporting filter fabric is a knitted fabric. In particular, the supporting filter fabric comprises a single layer, which is formed jointly from thick thread elements and thin thread elements. Therefore, the supporting effect of the thin thread elements on the thick thread elements can be achieved particularly reliably. The filter fabric is comparatively low in height. In particular, the thick thread elements and the thin thread elements jointly form a knitted fabric.

In particular the filter fabric, in particular during operation of the filter component, is supported directly on the supporting fabric. In particular, the filter fabric and the supporting fabric lie directly next to each other. In particular, the filter fabric contacts the supporting fabric, in particular during operation. The filter component is in operation when an air flow flows through the filter fabric and the supporting fabric, or through the supporting filter fabric. The filter component is in operation in particular when cooling air flows through it in the through-flow direction. The filter component is in operation in particular when cooling air is sucked in through the filter component in the through-flow direction.

In particular, the thick thread elements have a greater rigidity than the thin thread elements. In particular, the thick thread elements are stiffer and more resistant to deformation than the thin thread elements when subjected to force.

In particular, the supporting fabric is provided for arrangement in the work apparatus so that it forms a part of the outer side of the work apparatus. Therefore, the supporting fabric can absorb the external forces acting on the filter component and protect the filter fabric from deformation or damage. In particular, the filter fabric is facing towards an inner region of the work apparatus.

In particular, in an alternative embodiment, the filter fabric is provided for arrangement in the work apparatus so that it forms a part of the outer side of the work apparatus. In particular, the filter fabric is arranged in the work apparatus so that it forms a part of the outer side. In particular, the supporting fabric is facing towards an inner region of the work apparatus. An arrangement of the filter fabric so that the filter fabric forms a part of the outer side of the work apparatus results in the filter fabric in particular being smoother than the supporting fabric, which has the advantage that the outer side is also smoother than in the reverse arrangement. Dirt and filtered particles then penetrate the supporting fabric to a reduced extent and cannot accumulate to the same extent. Due to vibrations during operation of the work apparatus and shocks, dirt and particles can be released and fall partially or completely from the filter fabric. Therefore, the cleaning of the filter component from the outside, for example with a brush, is facilitated.

In a particular further development of the invention, the filter component comprises a further supporting fabric. In particular, the further supporting fabric is woven from further thick thread elements. In particular, the further thick thread elements of the further supporting fabric in their own right form a knitted fabric. In particular, the further supporting fabric is designed independently of the supporting fabric. In particular, the filter fabric is arranged between the supporting fabric and the further supporting fabric. Therefore, the filter fabric is reliably protected from deformation and damage. In particular, the filter component comprises three layers.

In particular, the thick thread elements and the thin thread elements are interwoven by means of a plain weave. In a plain weave, each warp thread (warp) is placed alternately over and under a weft thread (weft) and each weft thread is placed alternately over and under a warp thread. In particular, the thick thread elements of the supporting fabric are interwoven in plain weave. In particular, the thin thread elements of the filter fabric are interwoven in plain weave. It can also be provided that the thick thread elements and the thin thread elements of the supporting filter fabric are interwoven in plain weave. In particular, the thick thread elements are warp threads of the supporting filter fabric and the thin thread elements are weft threads of the supporting filter fabric. Therefore, a small mesh size, in particular in the direction in which the thin thread elements run, can be achieved. This results in a good filtering effect. The plain weave is also referred to as tabby weave. The plain weave is also referred to as linen weave.

In particular, the thick thread elements of the supporting fabric are interwoven in their own right by means of a twill weave. In particular, the thin thread elements of the filter fabric are interwoven in their own right by means of a twill weave. It can also be provided that the thick thread elements and the thin thread elements of the supporting filter fabric are interwoven in twill weave. The twill weave is characterized by a characteristic diagonal pattern, which occurs due to the specific arrangement of the warp and weft threads. In twill weave, the weft thread is guided over one warp thread, then through under at least two warp threads, then again over one warp thread and so on. This rhythm is continued offset by one warp thread in the next row. This offset always take place in the same direction. This leads to a surface structure with diagonal ridges, which are referred to as twill ridges.

In particular, the thick thread elements and the thin thread elements of the supporting filter fabric are interwoven to form a Dutch weave. In particular, the thick thread elements run in a straight line, in particular in one single direction, over their entire longitudinal extension. In particular, the thick thread elements are not bent due to the thin thread elements in the intersection regions with the thin thread elements.

It can be provided that the Dutch weave is a “plain Dutch”. In the so-called plain Dutch, the weft threads are packed tightly against the fabric when weaving in plain weave. The warp threads are spaced further apart from each other and are thicker than the weft threads. Due to the tight weave, the weft threads are slightly deformed at their intersection points, so that they are slightly flattened at the contact points.

Due to the thick thread elements of the Dutch weave, the Dutch weave has a very high mechanical stability and resistance and simultaneously displays a very good filtering effect.

By varying the thread thicknesses and the thread spacing of the warp threads, the filtration characteristics of the plain Dutch can be varied.

It can also be provided that the Dutch weave is an “armor weave”. In this type of weave, the warp threads are thin and are arranged closely to each other. The thick weft threads are packed tightly against each other. Therefore, the openings run diagonally to the fabric surface. Due to the design as an armor weave, the supporting filter fabric is mechanically very stable and tear resistant. With the design as an armor weave, the warp threads are in particular the thin thread elements, and the weft threads are in particular the thick thread elements.

In particular, a supporting mesh size of the supporting fabric is greater than a filter mesh size of the filter fabric. Therefore, a good filtering effect can be achieved by means of the filter fabric. The filter fabric can be simultaneously protected from deformation and/or damage by means of the supporting fabric. The supporting fabric can filter, in particular prefilter, coarse particles, while the filter fabric can filter fine particles with a smaller diameter than the coarse particles.

The filter component has a frame in particular. The frame delimits a structural unit made of filter fabric and supporting fabric in relation to a through-flow direction of the cooling air from both sides. Therefore, the structural unit made of a filter fabric and supporting fabric is held together by the frame. In particular, the frame is injection molded around the filter fabric and the supporting fabric by means of injection molding. Obviously, this applies only to a subsection of the surface of the filter fabric and the supporting fabric. Also in a design of the filter component with a supporting filter fabric, it can be provided that the supporting filter fabric is bordered by the frame. The frame delimits the supporting filter fabric in relation to the through-flow direction of the cooling air from both sides. In particular, the frame is injection molded around the supporting filter fabric by means of injection molding.

In particular, the thick thread elements and/or the thin thread elements are made from metal, in particular from corrosion-resistant metal, in particular from stainless steel. This results in a high mechanical stability of the filter fabric and/or the supporting fabric or the supporting filter fabric.

It can also be provided that the thick thread elements and/or the thin thread elements are made from plastic. This applies both for designs of the filter component with a supporting fabric and a filter fabric as well as with a supporting filter fabric. Therefore, the filter component can be produced in a simple and cost-effective manner.

It can also be provided that the thick thread elements are made from metal, in particular from corrosion-resistant metal, in particular from stainless steel, and the thin thread elements are made from plastic or vice versa. This applies both for designs of the filter component with a supporting fabric and a filter fabric as well as with a supporting filter fabric. Therefore, the filter component can be produced stably and simultaneously simply and cost-effectively.

In particular, the filter component has at least two connecting ribs. The connecting ribs are arranged on the thin thread elements and/or the thick thread elements. In particular, the connecting ribs are provided for arrangement on the outer side of the work apparatus. In particular, the at least two connecting ribs strengthen the frame. In particular, the at least two connecting ribs each connect two opposite points of a circumferential frame of the frame to each other.

The filter component has a largest extension measured perpendicular to the through-flow direction. The at least two connecting ribs run in a region, which extends over at least 30% of the largest extension, in particular intersection-free, in particular substantially parallel to each other. This facilitates cleaning of the filter component. In particular, in this region, the space between the at least two connecting ribs is free from transverse ribs running transversely to the at least two connecting ribs. In the running direction of the at least two connecting ribs, the filter component can therefore be swept over in this region with a brush, undisturbed by transverse ribs.

In particular, the at least two connecting ribs enclose at least a part of the thick thread elements and a part of the thin thread elements in relation to the through-flow direction of the cooling air from both sides. Therefore, the thin thread elements and the thick thread elements, in particular the supporting fabric and the filter fabric, are reliably connected to each other.

In a handheld work apparatus according to the invention, having a filter component in one of the above-described variants, it can be provided that the filter component forms a part of an outer side of the work apparatus. In particular, cooling air can flow through the filter component in a through-flow direction from the outside into an inner region of the work apparatus. Therefore, the cooling air can be filtered. Simultaneously, the filter component is mechanically stable.

In particular, the work apparatus comprises a tool having a longitudinal center axis. In particular, the longitudinal center axis of the tool is arranged between the at least two connecting ribs, when viewed in the through-flow direction of the cooling air. Therefore, the filter component, in particular the at least two connecting ribs serve as gauge for the using the tool. If, for example, the tool is concealed by a workpiece, the at least two connecting ribs, or their course, gives information about the position of the longitudinal axis of the guide bar for the tool.

In a particular further development of the invention, the filter component can be fastened by a single, in particular central, fastening element on a base body of the work apparatus. This enables simple and fast fastening of the filter component. Similarly, a fast exchange and/or an uncomplicated cleaning of the filter component is possible.

The invention further relates to a filter component for filtering cooling air for a handheld work apparatus, wherein the filter component comprises a frame and a woven fabric, wherein the filter component is provided for cooling air to flow through in a through-flow direction, wherein the frame encloses the woven fabric from both sides in relation to the through-flow direction and runs in a closed manner around the through-flow direction, wherein the woven fabric has a through opening penetrating the woven fabric completely in the through-flow direction for feeding-through a pin during production of the filter component,

wherein the filter component comprises a blocking element, and wherein cooling air is prevented from flowing through the filter component in the through-flow opening in the region of the through opening by the blocking element.

Cooling air flowing through the filter component in the through-flow direction in the region of the through opening for feeding-through a pin during production of the filter component is prevented by the blocking element. This prevents a hole from remaining in the woven fabric, which negatively affects the filtering effect, due to the through opening which is used during the production of the filter component for feeding-through the pin. Therefore, the filter component achieves a good filtering effect.

In particular, the through opening, in particular an edge of the through opening, is surrounded by material of the frame. Due to this material of the frame that is located on the edge of the through opening, a supporting structure is created in a simple manner, on which the blocking element can be arranged. The blocking element can be supported on this material of the frame that is located on the edge of the through opening.

In particular, the frame comprises a circumferential frame and at least one connecting structure. The circumferential frame runs, in particular in a closed manner, around the edge of the fabric. The connecting structure connects two opposite points of the circumferential frame to each other. Therefore, the filter component, in particular the frame, is more stable, in particular stiffer. The through opening is arranged in particular in the region of the connecting structure, in particular at a distance from the circumferential frame. Therefore, the fabric can be positioned near to the centroid of the fabric or even in the centroid of the fabric by the pin during the casting step to produce the frame. This enables reliable positioning of the fabric with as few pins as possible, in particular only with a single pin. It can also be provided that the fabric is held with two or more pins during the casting step. In particular, this is done by means of the further pins analogously to the manner described for the at least one pin.

In particular, the through opening is covered by the connecting structure. In particular, the blocking element is formed by the connecting structure. Therefore, the blocking element can be produced in a simple manner while producing the frame, in particular during the casting step. Therefore, the material of the frame can be used to produce the blocking element. This is saves on materials and costs.

In particular, the blocking element is an overlap section, which covers, in particular completely covers the through opening. In particular, the overlap section is arranged above the through opening. In particular, the overlap section covers the through opening when viewed in the through-flow direction, in particular completely. In particular, the overlap section is a component of the connecting structure, in particular the frame.

The frame has a frame thickness measured in the through-flow direction in the region around the through opening. The overlap section has an overlap thickness measured in the through-flow direction.

In particular, the overlap thickness is at most 50%, in particular at most 20%, in particular at most 5% of the frame thickness. Therefore, the blocking element, in particular the overlap section, can be produced in a material-saving manner.

In particular, the overlap thickness is at least 1% of the frame thickness. Therefore, the blocking element, in particular the overlap section, is thick enough, in order to prevent cooling air from flowing through the through opening.

In particular, the overlap thickness is from 0.01 mm to 5 mm, in particular from 0.05 mm to 2 mm.

In particular, the blocking element is formed by material of the frame.

In particular, the blocking element covers the through opening in the manner of a hood. Therefore, the blocking element is produced both in a material-saving and stable manner. In particular, therefore, the blocking element can be produced during the casting step in a simple manner.

The invention further relates to a method for producing a filter component for filtering cooling air for a handheld work apparatus. It is provided that the filter component comprises a frame and a fabric, wherein the filter component is provided for cooling air to flow through in a through-flow direction, wherein the frame encloses the fabric, that the fabric is recast between a first tool half and a second tool half in a casting step during production of the filter component such that this creates the frame, wherein the fabric has a through opening, that at least one pin is guided through the through opening during the casting step in order to hold the fabric in position, that cooling air flowing is prevented from flowing through the filter component in the through-flow direction in the region of the through opening by the provision of a blocking element, and in particular that the blocking element is formed by the frame.

Due to this method, a filter component can be produced with a good filtering effect in a simple manner.

In particular, the blocking element is formed during the casting step. In particular, the material for producing the frame penetrates into the region between the pin and the casting tool during the casting step. It can be provided that a space into which the material can penetrate during the casting step is always present between the pin and the casting tool. However, it can also be provided that the pin rests at the start of the casting step against a second tool half of the casting tool and that a space occurs between the pin and the second tool half during the casting step.

In particular, the pin is pretensioned in the direction of the second tool half, in particular by means of a spring. The tension force of the pretension and the pressure with which the material is applied during the casting step are matched to each other, so that the pin is moved away from the second tool half counter to the direction of the tension force by the material during the casting step. This creates a space between the second tool half and the pin, into which the material penetrates. Therefore, the blocking element, in particular the overlap section is formed. The through opening of the fabric is in particular not filled by material.

Alternatively to the blocking element formed by an overlap section, it can be provided that the blocking element is formed by a closure element. In particular, the through opening is sealed with the blocking element, in particular the closure element. In particular, the closure element is a plug in the through opening. In particular, the closure element is made from elastomer, in particular from thermoplastic elastomer.

In particular, in an associated method during the casting step, a holder opening completely penetrating the frame in the direction from the first tool half of the casting tool to the second tool half is created where the pin is located in the frame. In particular, the frame is created around the holder opening at the same time as the holder opening. In particular, the pin, which holds the fabric in position during the casting step, penetrates the fabric at a point which is over-molded during the casting step in such a way that the frame is created at this point, or around this point. In particular, the holder opening is sealed with the closure element in a following sealing step.

This avoids a hole caused by the pin remaining in the fabric in the finished filter component. Instead, this hole occurs in the region of the frame as a through opening and is subsequently closed, in particular filled, by the closure element. Therefore, neither visual nor functional disadvantages arise and simultaneously the filter component, in particular the fabric, is positioned during the casting step.

In particular, the pin is guided through the through opening during the casting step. In particular, the fabric is non-detachably threaded onto the pin with the through opening during the casting step. Therefore, it is ensured that the fabric is non-detachably positioned between the two tool halves. In particular, the pin contacts both the first tool half as well as the second tool half during the casting step. Therefore, the fabric is threaded non-detachably on the pin. However, it can also be provided that the pin projects merely into the other tool half in such a way that the other tool half prevents removal of the fabric threaded on the pin from the pin.

In particular, the fabric is resistant to bending. Therefore, the fabric can be threaded on the pin and be reliably positioned between the two tool halves.

In particular, the frame is produced in the casting step by means of an injection molding method, in particular by means of a plastic injection molding method. This enables simple production of the frame and of the filter component.

In particular, the closure element is cast, while the filter component is located between the first tool half and the second tool half. In particular, between the casting step and the sealing step, the filter component is located uninterrupted between the first tool half and the second tool half. Therefore, cost-effective and fast production of the filter component is possible.

In particular, the filter component has a sealing element for contact with a base body of the handheld work apparatus and for sealing between the frame and the base body. In a particular further development of the invention, the sealing element is produced in the sealing step. Therefore, both the closure element as well as the sealing element can be produced in one and the same method step, specifically in the sealing step. This saves time and costs.

In particular, the sealing element and the closure element are cast in a single casting step. In particular, the sealing element and the closure element are made of the same material, in particular are monolithic.

In particular, the holder opening serves to vent air displaced by the material during pouring in of the material for producing the sealing element. Therefore, the sealing element can be produced quickly and simply. Due to the venting through the holder opening, the air displaced by the material of the sealing element escapes simply and quickly. The sealing element can therefore be produced with a uniform consistency, in particular without bubbles.

In particular, the frame has a duct for receiving the sealing element. The duct runs in particular on the edge of the frame. The holder opening is in particular arranged at a distance from the edge of the frame. In particular, the duct and the holder opening are connected to each other via a connecting duct of the frame. In this manner, the sealing element can be produced in the duct on the edge of the frame during the sealing step. The material for producing the sealing element can also flow further into the connecting duct and to the holder opening simultaneously. Therefore, the closure element can be produced in the holder opening. Due to the design of the frame having a duct and a connecting duct to the holder opening, production is possible both of the sealing element as well as of the closure element in a single sealing step in a simple manner.

In particular, the frame has a feed opening for pouring in the material to produce the sealing element. Due to the feed opening, the material for producing the sealing element gets into the duct during the sealing step. In particular, the material for producing the sealing element gets from the duct into the connecting duct and reaches the holder opening during the sealing step. The material for producing the sealing element is also used to produce the closure element in this manner.

In particular, the fabric is threaded on the pin with its through opening before the casting step and then rests on a contact surface of a contact element. In particular, the contact surface is firstly arranged at a distance from the first tool half. Due to this distance of the contact surface from the first tool half, the fabric can be gripped without a problem at the edge, when it is being positioned and threaded onto the pin. In particular, this is also possible by means of a robot, in particular by means of a robot arm.

In particular, the fabric is pressed against the contact surface after threading the fabric with a holding element, which protrudes from the second tool half. Therefore, the fabric is at least temporarily secured in its position during subsequent movements of the fabric.

In particular, after threading the fabric, the fabric is moved towards the first tool half together with the contact element and the second tool half, so that the fabric rests both against the first tool half as well as the second tool half. In particular, the distance between the contact element and the first tool half is smaller than before at this point in time. In particular, there is no longer any distance between the contact surface and the first tool half. Therefore, the fabric can easily be brought into the position in which it is intended to be during the casting step for producing the frame.

In particular, the first tool half and the second tool half form the casting mold, in particular the casting tool, for producing the frame during the casting step.

In particular, the filter component is provided for the purpose of forming a part of an outer side of the work apparatus.

The invention further relates to a handheld work apparatus comprising a base body and a filter component for filtering cooling air, wherein the filter component can be fastened to the base body in relation to a fastening direction by means of the fastening element, wherein the filter component has a frame, wherein the filter component has a sealing element, circulating along a circulation direction, for sealing between the frame and the base body, wherein the sealing element is arranged in the fastening direction between the frame and the base body, wherein the work apparatus comprises at least one abutment element between the base body and the frame, wherein the abutment element limits the approach of the frame and base body in the fastening direction during the fastening of the filter component to the base body.

This aspect of the invention is based on the knowledge that, when fastening a generic filter component by means of the fastening element, in particular in the case of filter components with a large filter surface, undesired fitting inaccuracies may occur, which can lead to the sealing between the base body and filter components by means of the sealing element not being reliable. Although a pressure could be exerted on the filter component against the base body by means of the fastening element that is so large that the filter component with its frame presses the sealing element all over onto the base body, this may lead to undesired great deformation or compression of the sealing element. This results in premature wear of the sealing element and sometimes a leaking at that point on the sealing element that has been too greatly compressed.

According to the aspect of the invention, an abutment element is to locally prevent the undesired, in particular elastic, deformation, in particular compression, of the sealing element. For this, the work apparatus has at least one abutment element between the base body and the frame. The abutment element restricts the frame from approaching the base body in the fastening direction during the fastening of the filter component to the base body. In particular, the abutment element bridges a gap between the base body and the frame locally, in particular in a locally limited manner. In particular, the abutment element bridges a gap between the base body and the frame in a locally limited manner in relation to the circulation direction of the sealing element. Therefore, the frame of the filter component can be pressed at a point remote from the abutment element with sufficient force by means of the fastening element in the direction towards the base body of the handheld work apparatus, so that the sealing element rests at least both against the frame as well as the base body in the desired form. An undesired great approach between the frame and base body is prevented at the site of the abutment element due to the abutment element resting both against the base body as well as the frame. Therefore, an undesirably large, in particular elastic, deformation, in particular compression, of the sealing element is prevented. Therefore, it is achieved in a simple manner that the sealing element rests against both the base body as well as the frame in the desired form everywhere along its circulation direction. Therefore, the filter component can be fastened to the base body by means of the fastening element in a simple manner and simultaneously a good sealing effect of the sealing element can be achieved. In particular, the sealing element circulates along the circulation direction in a closed manner. In particular, the sealing element circulates around the fastening direction in a closed manner.

In particular the filter component forms a part of an outer side of the work apparatus. In particular, the filter component is fastened to the base body.

In particular, the at least one abutment element limits a, in particular elastic, compression, in particular deformation, of the sealing element in the fastening direction.

In particular, both the frame as well as the base body are harder than the sealing element. In particular, the sealing element is elastic. In particular, the sealing element is a thermoplastic elastomer.

In particular, the abutment element only extends over a local subsection of a full circuit in relation to the circulation direction of the sealing element. The subsection corresponds in particular to an angular range of <20°. In particular, the angular range is >0.5°. In particular, the abutment element bridges the gap between the frame and the base body in such a way that a distance between the frame and the base body, measured in the fastening direction, extends the circulation direction, in particular directly, in front of the abutment element, and that a second distance, measured in the fastening direction, extends in the circulation direction, in particular directly, behind the base body.

In particular, the filter component comprises a fabric. The fabric is framed, in particular by the frame. In particular, the fabric is at least partially made from metal. In particular, the frame is made from plastic. With this material combination, fitting accuracy of the filter component to the base body so that the sealing element lies everywhere as desired is particularly hard to achieve. Due to the different materials of the filter component, the component distorts, in particular in the case of temperature fluctuations.

In particular, only one single fastening element is provided for fastening the filter component to the base body. When fastening with only one single fastening element, in particular one single screw, the fitting accuracy of the filter component to the base body of the handheld work apparatus is particularly important. In this case, specifically any offset of distortion of the filter component by a second fastening element is not possible. Due to the single fastening element, a particularly convenient fastening of the filter component to the base body is possible, however. In particular, the fastening element, in particular the single fastening element, is arranged spaced apart from an edge of the frame. Therefore, the fastening element can be arranged close to or even in the centroid of the filter component. Therefore, a good and simple fastening of the filter component to the base body is possible.

In particular, the sealing element has a compression height, measured in the fastening direction, at a compression point between the frame and the base body in the completely compressed state. In particular, the sealing element has a sealing element height, measured in the same direction, at the same compression point in the non-compressed state. Optionally, the at least one abutment element limits the compression of the sealing element in the fastening direction at the compression point in such a way that the compression height is at least 50%, in particular at least 70%, in particular at least 80%, in particular at least 90%, in particular at least 95%, of the sealing element height. Therefore, undesirably great compression of the sealing element is avoided. Therefore, it is ensured that the sealing element reliably seals the space between the base body and the frame of the filter component. The service life of the sealing element is not limited by undesirably excessive compression of the sealing element.

In particular, the frame has a frame edge, encircling it in the circulation direction, in particular in a closed manner, and/or the base body has a base body surface, encircling it in the circulation direction, in particular in a closed manner. In particular, the frame edge is a surface of the frame facing towards the base body. In particular, the frame edge is adjacent, in particular directly adjacent, to the sealing element. In particular, the at least one abutment element protrudes beyond the frame edge and/or beyond the base body surface in the fastening direction. In particular, the at least one abutment element is fixed to the frame of the filter component or to the base body of the handheld work apparatus. In particular, the at least one abutment element is made of the same material as the frame or the base body, in particular monolithic. Therefore, the at least one abutment element can be produced in a simple manner. Therefore, the at least one abutment element can be positioned during the production of the handheld work apparatus in a simple manner. Therefore, the abutment element is securely held at the desired point.

In particular, a possible distance between the sealing element and the at least one abutment element, measured in the direction perpendicular to the fastening direction, is smaller than five times, in particular three times, in particular once sealing element height. Therefore, the abutment element works close to the sealing element. Therefore, it can be ensured in a simple manner that the sealing element is not too greatly compressed. It can also be provided that there is no distance at all between the sealing element and the at least one abutment element.

In a particular further development of the invention, at least two, in particular several abutment elements are provided which are spaced apart from each other in relation to the circulation direction. Therefore, excessive compression of the sealing element at several points along the circulation direction can be prevented by means of the at least two, in particular by means of the several abutment elements.

The invention further relates to a filter component for filtering cooling air for a handheld work apparatus, wherein the filter component is provided to form a part of an outer side of the work apparatus and to be mounted on a base body of the work apparatus, wherein the filter component comprises a gauge element for aligning the work apparatus, in particular for aligning a tool of the work apparatus,

wherein the filter component has a sealing element for contact with the base body of the handheld work apparatus and for sealing between the filter component and the base body, and wherein the gauge element and the sealing element are made from the same material.

According to this aspect of the invention, the filter component for filtering cooling air for a handheld work apparatus is provided to form a part of an outer side of the work apparatus and to be mounted on a base body of the work apparatus. The filter component comprises a gauge element for aligning the work apparatus, in particular for aligning a tool of the work apparatus. The filter component has a sealing element for contact with the base body of the handheld work apparatus and for sealing between the filter component and the base body. Therefore unfiltered cooling air is prevented from penetrating into the base body of the handheld work apparatus. A possible gap between the base body of the work apparatus and the filter component is sealed by the sealing element. Due to this possible gap, that is not present due to the invention, unfiltered cooling air could otherwise be sucked in. A very good filtering effect of the filter component is achieved by the sealing element. According to the invention, the gauge element and the sealing element are made from the same material as each other. In particular, the gauge element and the sealing element are formed from an identical material. In particular, the gauge element and the sealing element consist of the same material. This enables simple production both of the gauge element as well as the sealing element. In particular, the gauge element and the sealing element can be produced together. Only one single material has to be used to produce the gauge element and the sealing element. This saves production costs and simplifies the storage.

In particular, the gauge element and the sealing element are designed from the same material as each other, in particular they are monolithic, as a gauge and sealing element. In particular, the gauge element and the sealing element are designed contiguously to each other as a gauge and sealing element. This enables simple production both of the gauge element as well as the sealing element. The gauge element and the sealing element can be produced together, in particular cast, in particular injection molded, in a single method step by the joint monolithic design as a gauge and sealing element. The joint production of the gauge and the sealing element as a monolithic gauge and sealing element saves costs and time.

In particular, both the gauge element as well as the sealing element are made from an elastomer, in particular from a thermoplastic elastomer. Therefore, simple production of both the gauge element as well as the sealing element is possible. Both the gauge element as well as the sealing element can be produced in particular in a single casting step, in particular injection molding step.

In particular, the filter component has an inner side facing towards the base body of the handheld work apparatus in the installed position of the filter component. In particular, the filter component has an outer side facing away from the base body of the handheld work apparatus in the installed position of the filter component. In particular, the filter component has at least one through-flow opening, in particular at least two, in particular exactly two, in particular exactly four through-flow openings. In particular, the at least one through-flow opening completely penetrates the filter component from the inner side to the outer side. This applies in particular for all through-flow openings. In particular, the gauge and sealing element extends through the at least one through-flow opening. Therefore, the gauge and sealing element can be produced in a single casting step in a simple manner. The gauge and sealing element simultaneously seals the at least one through-flow opening during production of the gauge and sealing element. Therefore, unfiltered cooling air cannot flow through the filter component through the at least one through-flow opening. This increases the filtering effect of the filter component.

In particular, the filter component has a frame. In particular, the frame has a duct on the inner side of the filter component to receive the sealing element. In particular, the frame has a gauge element duct on the outer side of the filter component to receive the gauge element. When producing the sealing element, the material for producing the sealing element can be cast in the duct for receiving the sealing element, in particular it is injection molded, and can therefore expand in the duct. In particular, the sealing element then protrudes from the duct. In particular, an edge of the duct for receiving the sealing element has a lower height than the height of the sealing element. When producing the gauge element, material for producing the gauge element can be cast in the gauge element duct, in particular injection molded, and can expand in the gauge element duct. Therefore, simple production both of the sealing element as well as the gauge element is possible.

In particular, the at least one through-flow opening connects the duct for receiving the sealing element and the gauge element duct for receiving the gauge element to each other. In particular, the duct for receiving the sealing element is designed on the inner side of the filter component. In particular, the gauge element duct for receiving the gauge element is designed on the outer side of the filter component. Due to the at least one through-flow opening, it is possible to produce both the gauge element as well as the sealing element in a single casting step in a simple manner. Therefore, the material for producing the gauge and sealing element can be applied only to one single side of the filter component. The material for producing the gauge and sealing element then flows from this side either in the duct for receiving the sealing element or in the gauge element duct for receiving the gauge element to the at least one through-flow opening and thus penetrates to the other side of the filter component, in order then to penetrate into the respective other duct. In particular, the feed point is located on the outer side of the filter component. In particular, the material for producing the gauge and sealing element is initially introduced into the gauge element duct for receiving the gauge element via the feed point and flows from there to the at least one through-flow opening. In particular, the material for producing the gauge and sealing element then flows through the at least one through-flow opening onto the inner side of the filter component into the duct for receiving the sealing element. In particular, the base body, in particular the frame, and the gauge element contrast in color. Therefore, the gauge element can be seen well. In particular, the gauge element contrasts with the color of the base body, in particular the frame.

In particular, the gauge element is arranged on the outer side of the filter component. Therefore, the gauge element can be seen quickly and easily.

In particular, the filter component for filtering cooling air is a component of a handheld work apparatus.

The handheld work apparatus with the filter component as described above with a gauge element on the outer side of the filter component in particular comprises a tool. The tool has a longitudinal extension. In particular, the gauge element has a piercing guide and a felling guide. It can also be provided that the gauge element has both a piercing guide as well as a felling guide. The piercing guide extends in particular substantially in the direction of the longitudinal extension in the installed position. The felling guide extends in particular substantially in the direction transverse to, in particular in the direction perpendicular to the direction of the longitudinal extension in the installed position. The piercing guide gives information about the course of the longitudinal extension of the tool to the user, even when the tool is not visible. This for example is helpful when the tool is concealed by a workpiece. For example, this can be the case with a handheld chainsaw when the tool designed as a guide bar with a chainsaw chain lies in a saw kerf. When felling a tree, the felling guide can indicate the fall direction of the tree.

In particular, a longitudinal direction of the piercing guide runs transverse, in particular perpendicular, to a longitudinal direction of the felling guide.

In particular, the piercing guide has a first piercing guide section and a second piercing guide section. In particular, the first piercing guide section and the second piercing guide section are designed spaced apart from each other in a view in the through-flow direction.

In particular, the felling guide has a first felling guide section and a second felling guide section. In particular, the first felling guide section and the second felling guide section are designed spaced apart from each other in a view in the through-flow direction.

In particular, the filter component of the handheld work apparatus is designed so that the monolithic, in particular materially uniform and contiguous design of the piercing guide of the gauge element and the felling guide of the gauge element cannot be seen on the outer side of the filter component. In particular, the piercing guide and the felling guide are arranged in such a way that the materially uniform, in particular monolithic design of the piercing guide of the gauge element and the felling guide of the gauge element cannot be seen on the outer side of the filter component. In particular, the piercing guide and the felling guide are arranged in such a way that they appear separated from each other by concealing areas, in particular by the frame. Therefore, a clear separation between the felling guide and the piercing guide is possible. This facilitates the orientation by means of the piercing guide and the felling guide.

The invention further relates to a method for producing a filter component for filtering cooling air for a handheld work apparatus. Consequently, the filter component is provided to form a part of an outer side of the work apparatus and to be mounted on a base body of the work apparatus. The filter component comprises a gauge element for aligning the work apparatus, in particular for aligning a tool of the work apparatus. The filter component has a sealing element for contact with the base body of the handheld work apparatus and for sealing between the filter component and the base body. The gauge element and the sealing element are cast in a single casting step. Therefore, a gauge and sealing element is formed. This is connected to the advantages described above in conjunction with the filter component. The gauge and sealing element is in particular monolithic. The method according to the invention can be further developed by the features described above in conjunction with the filter component. In particular, the gauge element and the sealing element are made from the same material and are contiguous with each other as a gauge and sealing element.

Exemplary embodiments of the invention are explained in the following using the figures, in which:

### BRIEF DESCRIPTION OF THE DRAWINGS

FIG. 1 shows a schematic illustration of a side view of a handheld work apparatus having a filter component for filtering cooling air,

FIG. 2 shows a faithful illustration of the filter component schematically illustrated in FIG. 1 in a side view,

FIG. 3 shows a faithful illustration of the filter component from FIG. 2 in a side view of the inner side of the filter component,

FIG. 4a shows a sectional illustration of a section through the faithful work apparatus and the faithful filter component with a supporting fabric arranged on the outer side and a filter fabric arranged on the inner side, along the section plane IV-IV marked in the schematic illustration according to FIG. 1,

FIG. 4b shows a sectional illustration analogous to FIG. 4a from an alternative exemplary embodiment of a filter component with a filter fabric arranged on the outer side and a supporting fabric arranged on the inner side,

FIG. 5 shows a sectional illustration analogous to FIGS. 4a and 4b in an enlarged detail view at the point marked with V in FIGS. 4a and 4b, from a further alternative exemplary embodiment of a filter component with a supporting fabric arranged on the outer side, a further supporting fabric arranged on the inner side and with a filter fabric arranged therebetween,

FIG. 6a shows a schematic illustration of a section of a first variation of the supporting fabric of the filter component from FIG. 1 to 5,

FIG. 6b shows a schematic illustration of a section of a first variation of the filter fabric of the filter component from FIG. 1 to 5,

FIG. 7a shows a schematic illustration of a section of a second variation of the supporting fabric of the filter component from FIG. 1 to 5,

FIG. 7b shows a schematic illustration of a section of a second variation of the filter fabric of the filter component from FIG. 1 to 5,

FIG. 8 shows a schematic perspective illustration of a section of a supporting filter fabric, which can be provided in the filter component according to FIG. 1 to 5 instead of the fabric provided there,

FIG. 9 shows a schematic illustration along the section plane IX marked in FIG. 8,

FIG. 10 shows the illustration of the filter component from FIG. 3 in an alternative embodiment of the filter component with a sealing element and abutment element,

FIG. 11 shows a perspective illustration of a first tool half of a casting tool with pins, onto which the fabric of the filter component is pinned,

FIG. 12 shows a sectional illustration of a section through the first tool half from FIG. 11 with fabric attached to the pin,

FIG. 13 shows a section analogous to the sectional illustration from FIG. 12 both through the first tool half and through the second tool half of the casting tool in a state in which the two tool halves are spaced apart from each other, the fabric however is pressed onto a contact surface of a contact element, projecting from the first tool half, by a holding element projecting from the second tool half,

FIG. 14 shows a sectional illustration of a section parallel to the section plane of the section from FIG. 13 in the same state of the casting tool,

FIG. 15 shows a section illustration of the casting tool analogous to the sectional illustration from FIG. 13, wherein the first tool half and the second tool half are brought as close together as possible and the fabric attached to the pin is located between the first tool half and the second tool half,

FIG. 16 shows a view of the filter component analogous to the view of FIG. 2, wherein an alternative exemplary embodiment for the filter component is shown in FIG. 16, in which the filter component has a gauge element,

FIG. 17 shows a sectional illustration of a section along the section plane XVII-XVII, marked in FIG. 16,

FIG. 18 shows a sectional illustration of a section along the section plane XVIII-XVIII, marked in FIG. 16,

FIG. 19 shows a perspective exploded illustration of the filter component from FIG. 16, which shows the form of the gauge and sealing element,

FIG. 20 shows a perspective partial exploded illustration of a part of the base body of the handheld work apparatus and the filter component from FIG. 16,

FIG. 21 shows a section through the filter component illustrated in FIG. 20 and the base body in the assembled state,

FIG. 22 shows a detailed illustration of a detail marked with XXII in FIG. 21,

FIG. 23 shows a schematic illustration of a section along the section plane XXIII-XXIII from FIG. 22,

FIG. 24 shows a schematic illustration of an alternative casting tool for producing an alternative exemplary embodiment for a filter component, wherein the fabric of the filter component is threaded between the two tool halves of the casting tool on a pin of the casting tool and the pin rests both against the first tool half as well as against the second tool half, and

FIG. 25 shows a schematic illustration analogous to FIG. 24, wherein the pin no longer rests against the second tool half, but is pushed back by material to produce the frame.

### DETAILED DESCRIPTION

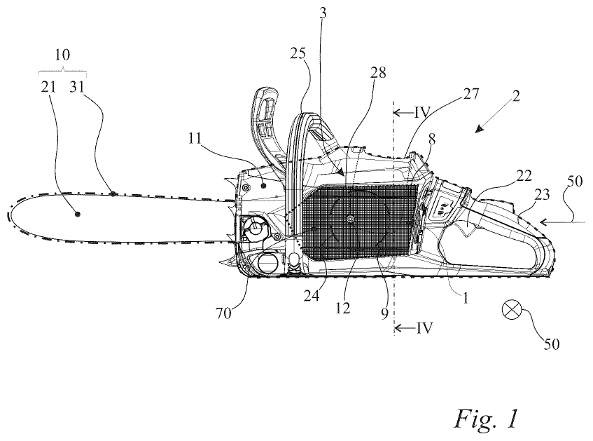

FIG. 1 shows a handheld work apparatus 2. The handheld work apparatus 2 in the exemplary embodiments is a hand-carried motor chain saw. However, the handheld work apparatus 2 may also be a brush cutter, a wood cutter, a saber saw, a vacuum and/or blower, a hedge trimmer, a cut-off machine, a pole pruner, a lawn mower or similar work apparatus. The work apparatus 2 can be carried when used as intended. The work apparatus 2 can be handheld when used as intended. In particular, the handheld work apparatus 2 is a motor chain saw. In the exemplary embodiments, the handheld work apparatus 2 is a so-called rear handle chainsaw. The handheld work apparatus 2 can even be a chainsaw, also referred to as an arboriculture saw.

The work apparatus 2 has a tool 10. In the exemplary embodiment, the tool 10 is a guide bar 21 with a chainsaw chain 31. The chainsaw chain 31 is guided on the guide bar 21. As illustrated schematically in FIG. 1 by a dashed line, the handheld work apparatus 2 has a motor 24 for driving the tool 10, in particular the chainsaw chain 31. In the exemplary embodiments, the motor 24 is an electric motor. The tool 10 can be a saw blade, a cutting wheel, a trimming line or similar. In the exemplary embodiments, the chainsaw chain 31 circulates around the guide bar 21 during operation. The motor 24 drives the chainsaw chain 31 in the exemplary embodiment. The motor 24 is arranged in a base body 11. The base body 11 has an outer housing.

The work apparatus 2 comprises a control handle 23 in all exemplary embodiments. A control element 22 is arranged on a control handle 23. The operator can set the power of the motor 24 or the rotational speed of the motor 24 or the tool 10, in particular the chainsaw chain 31, by means of the control element 22. The control handle 23 is a component of the base body 11 of the handheld work apparatus 2. The control handle is arranged on the rear end of the base body 11. The tool 10, in the exemplary embodiments the guide bar 21, projects from the base body 11 at the front end of the base body 11. In addition to the control handle 23, the work apparatus 2 comprises a loop handle 25. The loop handle 25 serves to carry and guide the work apparatus 2. The loop handle 25 is formed by a handle tube. The user can completely grasp the handle tube. The loop handle 25 is arranged between the control handle 23 and the tool 10. In particular, the loop handle 25 is arranged between the control handle 23 and the tool 10 in a side view.

The tool 10 is facing away from the user during operation of the work apparatus 2. The control handle 23 is facing towards the user during operation of the work apparatus 2.

The handheld work apparatus 2 comprises a filter component 1. The filter component 1 serves to filter cooling air. The filter component 1 is provided to form a part of an outer side 3 of the handheld work apparatus 2. The filter component 1 is provided to be mounted on the base body 11 of the work apparatus 2. In FIG. 1, the filter component 1 forms a part of the outer side 3 of the work apparatus 2 and is mounted on the base body 11 of the work apparatus 2. In the exemplary embodiment according to FIG. 1, the filter component 1 is fastened to the base body 11 by means of a fastening element 12. Cooling air can enter from the outside into the work apparatus 2 through the filter component 1. In the exemplary embodiment, the cooling air serves to cool the motor 24. The cooling air is cleaned of particles and impurities by means of the filter component 1.

In the exemplary embodiments, the work apparatus 2 comprises a blower (not shown). The blower serves to suck in the cooling air. The blower is arranged in the base body 11. The motor 24 drives the blower. The blower sucks in cooling air through the filter component 1 into the inside of the base body 11.

The filter component 1 is arranged on one side of the base body 11. In the exemplary embodiment, the tool 10 extends in a tool plane. The chainsaw chain 31 circulates in the tool plane. The tool plane divides the base body 11 into a first and a second half. The filter component 1 is completely arranged in one of the two halves. In a side view perpendicular to the tool plane, the filter component 1 can be seen and only partially conceals the loop handle 25. The loop handle 25 overlaps the base body 11.

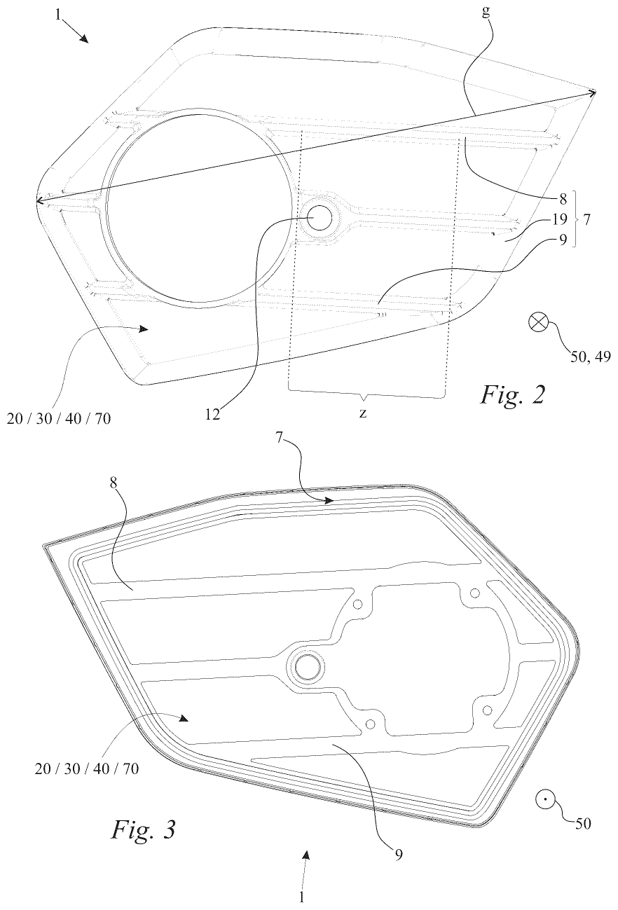

As illustrated in particular in FIGS. 2 and 3, the filter component 2 has a fabric 70. The filter component 1, in particular the fabric 70, comprises thick thread elements 4 and thin thread elements 5, which are illustrated in FIG. 6 to 9. The cooling air has to pass through both the thin thread elements 5 as well as the thick thread elements 4 to filter the cooling air. The thick thread elements 4 and the thin elements 5 are each thread-shaped. The thick thread elements 4 serve to support the thin thread elements 5. The thick thread elements 4 are thicker than the thin thread elements 5.

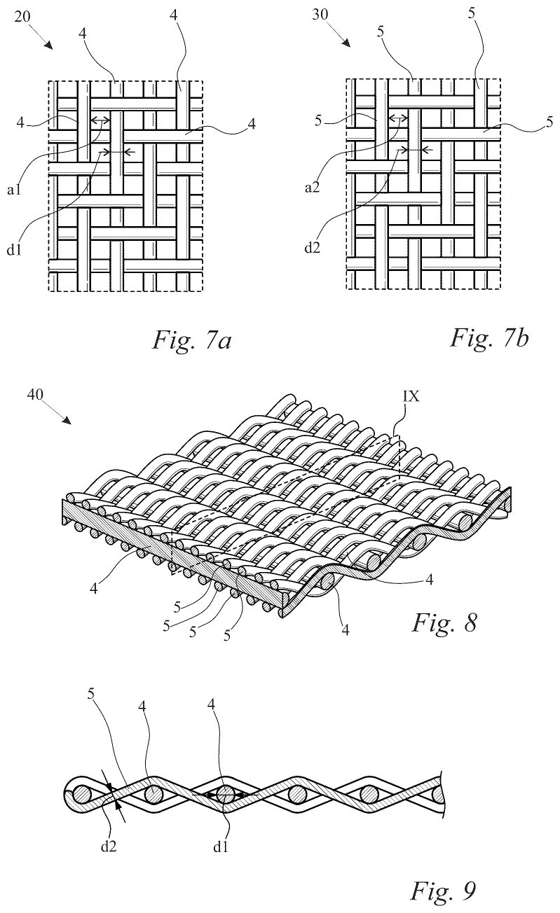

The thread elements 4, 5 are each elongated structures which extend along a longitudinal direction. A cross-section perpendicular to this longitudinal direction, which in particular does not have to be in a straight line, has a round, in particular circular outer contour. As illustrated in FIG. 6a or 7a, the thick thread elements 4 have a diameter d1. The diameter d1 is measured perpendicular to the longitudinal direction of the associated thick thread element 4. The diameter d1 corresponds to the largest extension of the associated cross-section of the thick thread element 4.

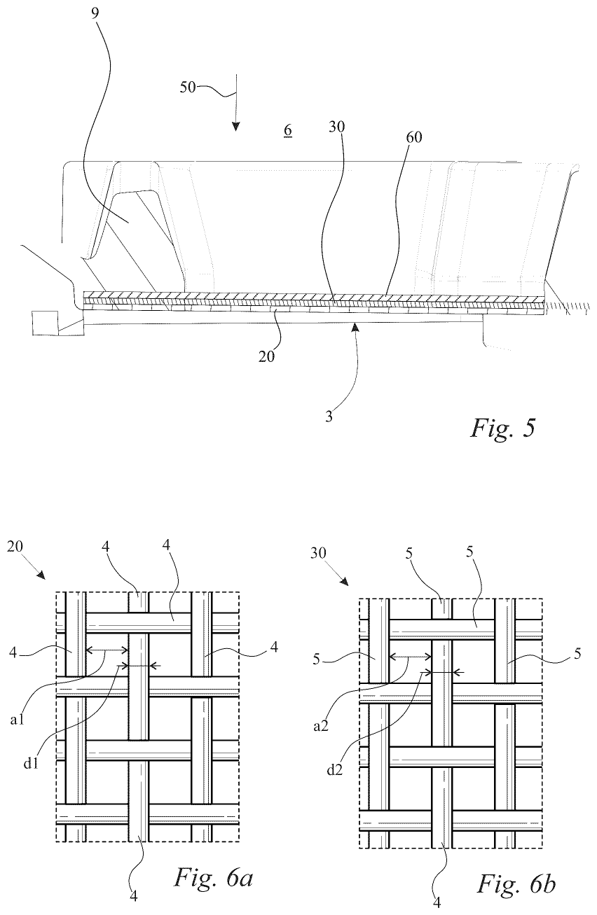

As illustrated in FIG. 6b or 7b, the thin thread elements 5 each have a diameter d2. The diameter d2 is measured perpendicular to the longitudinal direction of the associated thin thread element 5. The diameter d2 corresponds to the largest extension of the associated cross-section of the thin thread element 5. The diameter d1 of the thick thread elements 4 is greater than the diameter d2 of the thin thread elements 5. In the exemplary embodiment according to FIG. 1 to 7, the thick thread elements 4 are in their own right interwoven, in particular interlaced, to form a supporting fabric 20 and the thin thread elements 5 are in their own right interwoven, in particular interlaced, to form a filter fabric 30. A first variation of the structure of the supporting fabric 20 is illustrated in FIG. 6a. FIG. 7a shows a second variation of the structure of the supporting fabric 20. A first variation of the structure of the filter fabric 30 is illustrated in FIG. 6b. FIG. 7b shows a second variation of the structure of the filter fabric 30. FIG. 5 shows that the filter fabric 30 is supported on the supporting fabric 20 during operation. In particular, the filter fabric 30 is supported directly on the supporting fabric 20 during operation. During operation, the filter fabric 30 rests against the supporting fabric 20. The thin thread elements 5 of the filter fabric 30 contact the thick thread elements 4 of the supporting fabric 20 during operation. In particular, when cooling air flows through the filter component 1, the filter fabric 30 and the supporting fabric 20 are in contact with each other. However, it can also be provided that the filter fabric 30 and the supporting fabric 20 are always in contact with each other. The fabric 70 is formed jointly by the filter fabric 30 and the supporting fabric 20.

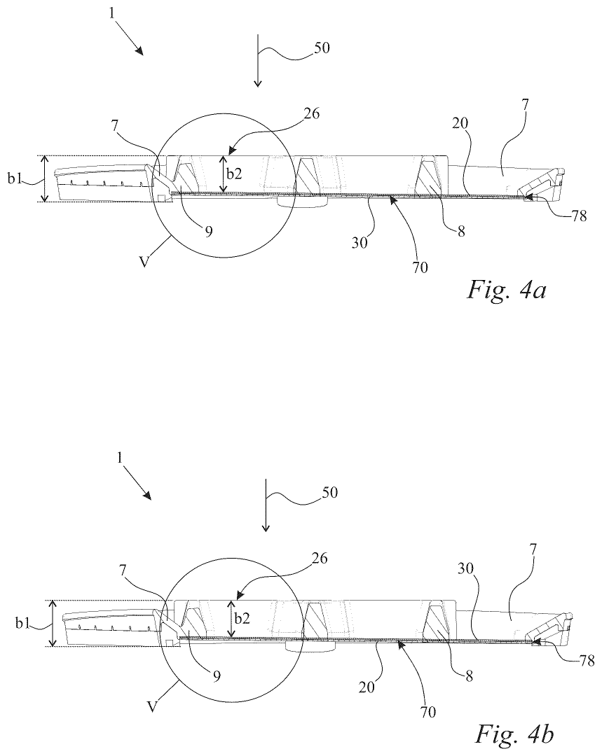

As illustrated in FIG. 4a or 5, the supporting fabric 20 is provided for arrangement in the work apparatus 2 so that it forms a part of the outer side 3 of the work apparatus 2. The filter fabric 30 is facing towards an inner region 6 of the work apparatus 2. However, a reverse arrangement of the supporting fabric 20 and the filter fabric 30 can also be provided, as illustrated in FIG. 4b. In an arrangement of the filter fabric 30 so that the filter fabric 30 forms a part of the outer side 3 of the work apparatus 2, the result is that the filter fabric 30 is smoother than the supporting fabric 20, which has the advantage that the outer side 3 is then also smoother than in the reverse arrangement. Dirt and filtered particles then penetrate the supporting fabric 20 to a reduced extent and cannot accumulate to the same extent. Due to vibrations during operation of the work apparatus 2 and shocks, dirt and particles can be released and fall partially or completely from the filter fabric 30. Therefore, the cleaning of the filter component 1 from the outside, for example with a brush, is facilitated.

As illustrated in FIG. 6a and FIG. 7a, the supporting fabric 20 has a supporting mesh size a1. The filter fabric 30 has a filter mesh size a2, illustrated in FIG. 6b and FIG. 7b. The mesh size is in each case the clear width between two adjacent thread elements running in the same direction. The mesh size defines which particle sizes are retained by the supporting fabric 20 or by the filter fabric 30. When the clear widths of a mesh in the two directions perpendicular to the longitudinal extension of the intersecting threads are different sizes, the mesh size corresponds to the smaller of the two clear widths. The supporting mesh size a1 of the supporting fabric 20 is greater than the filter mesh size a2 of the filter fabric 30.

As marked in FIG. 5, optionally a further supporting fabric 60 can be provided. In this case, the filter fabric 30 is arranged between the supporting fabric 20 and the further supporting fabric 60. The fabric 70 is then formed by the filter fabric 30, the supporting fabric 20 and the further supporting fabric 60. The further supporting fabric 60 is formed analogously to the supporting fabric 20 from further thick thread elements. The further thick thread elements are designed analogously to the thick thread elements 4. The further thick thread elements of the further supporting fabric 60 are in their own right interwoven, in particular interlaced, to form the further supporting fabric 60. The further supporting fabric 60 is designed independently of the supporting fabric 20. The further supporting fabric 60 is designed independently of the filter fabric 30. In the variations of the filter component 1, illustrated in FIGS. 4a and 4b, the supporting fabric 20 and the filter fabric 30 lie on each other in layers. In FIG. 5, the supporting fabric 20, the filter fabric 30 and the further supporting fabric 60 lie on each other in layers. In all cases, a two-ply or multi-ply filter is formed.

Alternatively to designing the filter component 1 with a supporting fabric 20 and a filter fabric 30, in the filter component 1 according to FIG. 1 to 5 it can be provided that the thick thread elements 4 and the thin thread elements 5 are interwoven, in particular interlaced, together to form a single supporting filter fabric 40. In this case, in particular no further supporting fabric 60 is provided. The filtering fabric 70 is then exclusively formed by the supporting filter fabric 40.

The supporting filter fabric 40 is illustrated in FIGS. 8 and 9. In the supporting filter fabric 40, the thick thread elements 4 ensure sufficient mechanical stability of the supporting filter fabric 40, and the thin thread elements 5 have the effect that the mesh size of the supporting filter fabric 40 is sufficiently small for a good filtering effect through the supporting filter fabric 40.

In the embodiment according to FIG. 6a, the thick thread elements 4 of the supporting fabric 20 are interwoven in plain weave. In an analogous manner, in FIG. 6b, the thin thread elements of the filter fabric 30 are likewise interwoven in plain weave. In particular, the thick thread elements 4 and the thin thread elements 5 of the supporting filter fabric 40 are interwoven in plain weave, analogously to the plain weave illustrated in FIGS. 6a and 6b. In the case of plain weave, each warp thread (warp) is placed alternately over and under a weft thread (weft) and each weft thread is placed alternately over and under a warp thread. The warp thread is a thread of a warp. The warp is the entire number of threads of the same length, which are spooled approximately parallel on a warp beam or several sectional warp beams and are fed from there in the longitudinal direction to the working point of the warp knitting machine. The thread inserted transversely into the fabric is referred to as a weft thread, which runs transversely, in particular at a right angle, to the warp threads. Here, the term thread can be replaced by wire in all word formations which contain it. In particular, this more accurately describes the situation for woven or knitted fabric made from metal (or also plastic). Accordingly, the warp threads can be referred to as warp wires and the weft threads can be referred to as weft wires.

In the embodiment according to FIG. 7a, the thick thread elements 4 of the supporting fabric 20 are interwoven in twill weave. In an analogous manner, in FIG. 6b, the thin thread elements of the filter fabric 30 are likewise interwoven in twill weave. In particular, the thick thread elements 4 and the thin thread elements 5 of the supporting filter fabric 40 are interwoven in twill weave, analogously to the twill weave illustrated in FIGS. 7a and 7b. The twill weave is characterized by a characteristic diagonal pattern, which occurs due to the specific arrangement of the warp and weft threads. In twill weave, the weft thread is guided over one warp thread, then through under at least two warp threads, then again over one warp thread and so on. This rhythm is continued offset by one warp thread in the next row. This offset always take place in the same direction. This leads to a surface structure with diagonal ridges, which are referred to as twill ridges.

The thick thread elements 4 have a greater rigidity than the thin thread elements 5. The further thick thread elements of the further supporting fabric 60 similarly have a greater rigidity than the thin thread elements 5. In the exemplary embodiments, the thick thread elements 4 and/or the thin thread elements 5 are made from metal, in particular from corrosion-resistant metal, in particular from stainless steel. It can also be provided that the thick thread elements 4 and/or the thin thread elements 5 are made from plastic. These material specifications apply both for the exemplary embodiments in which the filter component 1 comprises a supporting fabric 20 and a filter fabric 30 and optionally additionally a further supporting fabric 60, as well as for exemplary embodiments in which the filter component 1 comprises a supporting filter fabric 40. Material combinations are also conceivable. For example, the thick thread elements 4 can be made from metal, in particular from corrosion-resistant metal, in particular from stainless steel and the thin thread elements 5 can be made from plastic. Similarly, it is conceivable that the thick thread elements 4 are made from plastic and the thin thread elements 5 are made from metal, in particular from corrosion-resistant metal, in particular from stainless steel. In the case that the further supporting fabric 60 is provided, the further thick thread elements are made from the same material as the thick thread elements 4 of the supporting fabric 20. However, it can also be provided that the further thread elements of the further supporting fabric 60 are made from the respective material that is different from that the thick thread elements 4 of the supporting fabric 20.

In the exemplary embodiment according to FIG. 8, the thick thread elements 4 and the thin thread elements 5 of the supporting filter fabric 40 are interwoven to form a Dutch weave. In particular, in the Dutch weave, either the warp or the weft threads are placed closely in contact with each other that mesh is not visible anymore in the projection (zero-mesh), so that a very good filtering effect can be achieved. The filtering takes place through the intermediate spaces partially in the inside of the Dutch weave. If the warp threads are close to each other, this is also known as reverse Dutch or armor press fabrics. In the exemplary embodiment according to FIG. 8, the thick thread elements 4 run in the longitudinal direction without significant local curvature. Substantially, the thick thread elements 4 run almost in a straight line over their entire longitudinal extension. A slight curvature can also be provided over the entire longitudinal extension of the thread elements 4. In particular, the thick thread elements 4 are not curved in the intersection regions with the thin thread elements 5 in such a way that their course adapts to the course of the intersecting thin thread elements 4.

As illustrated in particular in FIGS. 2, 3, 10, 16, 19 and 20, the filter component 1 has a frame 7. The frame 7 encloses the fabric 70. As illustrated in FIGS. 4a and 4b, the filter component 1 is provided for cooling air to flow through in a through-flow direction 50. The through-flow direction 50 runs transverse, in particular perpendicular to the surface of the fabric 70, in particular to the surface of the supporting fabric 20 and/or the filter fabric 30, or the supporting filter fabric 40. In the installed state of the filter component 1, the through-flow direction 50 is transverse, in particular perpendicular to the outer side 3 of the work apparatus 2. It can also be provided that the through-flow direction 50 runs perpendicular to a tool plane of the tool 10. The frame 7, in particular a circumferential frame 19 of the frame 7, circulates in a closed manner around the through-flow direction 50. The circumferential frame 19 encloses the fabric 70 at an edge 78 of the fabric 70. The frame 7 delimits the fabric 70 in relation to the through-flow direction 50 of the cooling air from both sides of the fabric 70. In particular the frame 7 delimits an assembly, in particular a structural unit, made from filter fabric 30 and supporting fabric 20, in particular and further supporting fabric 60, in relation to the through-flow direction 50 of the cooling air from both sides of the assembly, in particular structural unit. In the exemplary embodiments, the frame 7 is injection molded by means of injection molding around the fabric 70, in particular around the filter fabric 30 and the supporting fabric 20, in particular and the further supporting fabric 60, in particular around its edge. The edge of the fabric 70, in particular the assembly, in particular the structural unit, made from the filter fabric 30 and the supporting fabric 20, is then accommodated in the frame 7.

The frame 7 projects beyond the fabric 70 in the direction towards the outer side 3. Therefore, the fabric 70 is at least a little bit protected from mechanical loads. The filter component 1 has an overall height b1, measured in the through-flow direction 50 (illustrated for all exemplary embodiments in FIGS. 4a and 4b by way of example). The frame 7 has a point at the greatest distance b2 to the fabric 70, wherein the greatest distance b2 is measured in the through-flow direction 50. In the exemplary embodiments, there is a region 26 of the frame 7, encircling in the through-flow direction 50, which has the greatest distance b2 to the fabric 70. The distance b2 is at least 50%, in particular at least 60%, of the overall height b1 of the filter component 1.

In the exemplary embodiments, the filter component 1 has at least one connecting rib 8, 9, in particular at least two connecting ribs 8, 9. The at least one connecting rib 8, 9 is arranged on the thin thread elements 5 and/or the thick thread elements 4. The at least one connecting rib 8, 9 is provided for arrangement on the outer side 3 of the work apparatus 2. In the installed state of the filter component 1, the at least one connecting rib 8, 9 forms part of the outer side 3 of the work apparatus 2. As illustrated in FIG. 2, the at least one connecting rib 8, 9 connects two points of the circumferential frame 19 that are opposite each other.

The filter component 1 has a largest extent g, measured perpendicular to the through-flow direction 50. At least two connecting ribs 8 and 9 have a region z, as marked in FIG. 2. The length of the region z, measured in the longitudinal direction of the connecting rib 8 and/or the connecting rib 9, is at least 20%, in particular at least 30% of the largest extent g of the filter component 1. The at least two connecting ribs 8, 9 run intersection-free in the region z. The at least two connecting ribs 8 and 9 are designed separately from each other in the region z. The at least two connecting ribs 8 and 9 do not intersect in the region z. The at least two connecting ribs 8 and 9 do not make contact in the region z. A rib does not run transverse to the connecting ribs 8 and 9 in the region z. In the exemplary embodiments, the connecting ribs 8 and 9 run substantially parallel to each other. The space between the at least two ribs 8 and 9 is free from transverse ribs running transverse to the at least two ribs 8 and 9 in the region z.

As illustrated in FIG. 5 by way of example for the connecting rib 9, the at least two connecting ribs 8, 9 enclose at least one part of the thick thread elements 4 (contained in the supporting fabric 20 in FIG. 5) and at least one part of the thin thread elements 5 (contained in the filter fabric 30 in FIG. 5) in relation to the through-flow direction 50 of the cooling air from both sides.

As illustrated in FIG. 1, the filter component 1 can be fastened by the single fastening element 12 to the base body 11 of the work apparatus. The fastening element 12 is the single component by means of which the filter component 2 is fastened to the base body 11. The fastening element 12 is arranged centrally on the filter component 1. The fastening element 12 is arranged on the filter component 1 at a distance to the circumferential frame 19, measured in particular in the direction perpendicular to the through-flow direction 50. The fastening element 12 is arranged in the surface of the fabric 70 at a distance to the edge 78 of the fabric 70, measured in particular in the direction perpendicular to the through-flow direction 50. In particular, the fastening element 12 can be fastened approximately in the center of the filter component 1, in particular the center of the fabric 70, in particular in the centroid of the surface assigned to the filter outer contour 28, perpendicular to the tool plane of the tool 10 (FIG. 1) in the side view.

The fastening element 12 completely penetrates the fabric 70 in the through-flow direction 50. In the exemplary embodiments, the fastening element 12 is arranged in the region of a connecting rib, as illustrated in FIG. 2, for example. The fastening element 12 completely penetrates the connecting rib in the through-flow direction 50. In the exemplary embodiments, the fastening element 12 is a screw. The screw is screwed into the base body 11 of the work apparatus 2 through the filter component 1. Therefore, the filter component 1 is pushed against the base body 11.

To fasten the filter component 1 to the base body 11 by means of the fastening element 12, the filter component 1 can be made to approach the base body 11 during the fastening in a fastening direction 49. The fastening direction 49 is illustrated in FIG. 2. In the exemplary embodiments, the fastening direction 49 runs in the same direction as the through-flow direction 50. The fastening direction 49 runs transverse, in particular perpendicular to the surface of the fabric 70, in particular to the surface of the supporting fabric 20 and/or the filter fabric 30, or the supporting filter fabric 40. In the installed state of the filter component 1, the fastening direction 49 is transverse, in particular perpendicular to the outer side 3 of the work apparatus 2. The fastening element 12 fastens the filter component 1 to the base body 11 in relation to the fastening direction 49.

In the fastened state of the filter component 1, the filter component 1 forms part of the outer side 3 of the work apparatus. Cooling air can then flow from the outside into the inner region 6 of the work apparatus 2 through the filter component 1 in the through-flow direction 50.

The outer housing of the base body 11 has a housing outer contour 27 perpendicular to the tool plane of the tool 10 in a side view, as illustrated in FIG. 1. The housing outer contour 27 delimits an imaginary housing surface in an imaginary projection onto the tool plane. The projection takes place in the direction perpendicular to the tool plane. The filter component 1, in particular the fabric 70, has a filter outer contour 28 in an imaginary projection onto the tool plane. The projection takes place in the direction perpendicular to the tool plane. The filter outer contour 28 delimits an imaginary filter surface in the tool plane. The filter surface is at least 5%, in particular at least 10%, in particular at least 15%, in particular at least 18% of the housing surface. Therefore, the filter component 1 takes up a large part of the outer side 3 of the work apparatus 1 in a side view. The filter component 1 is large in relation to the filter components, known from the prior art. When fastening with only one single fastening element 12, there can be severe distortion of the filter component 1, absolutely viewed due to the large size of the filter component 1. The filter component 1 can rest with its edge at one point against the base body 11, and not at another, in particular opposing point.

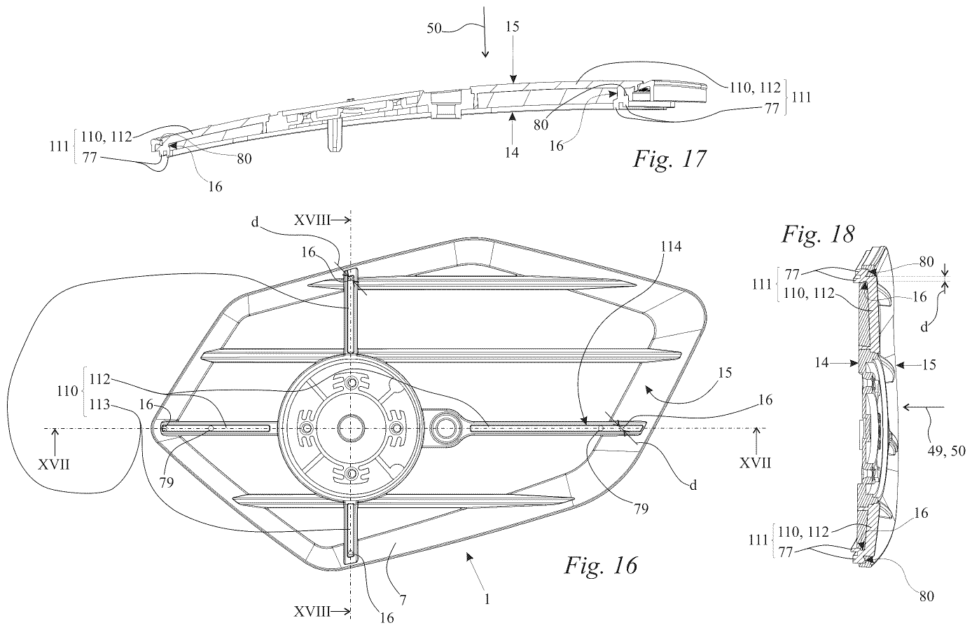

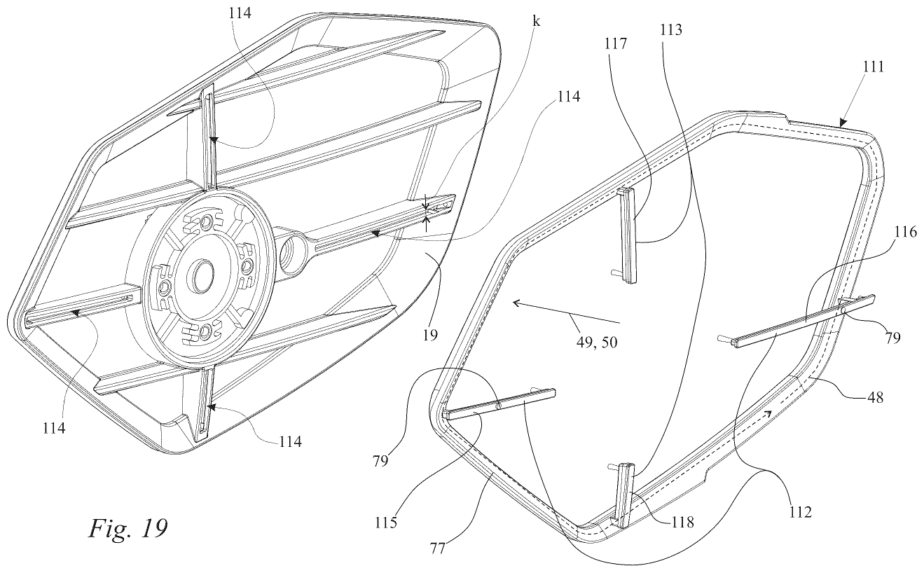

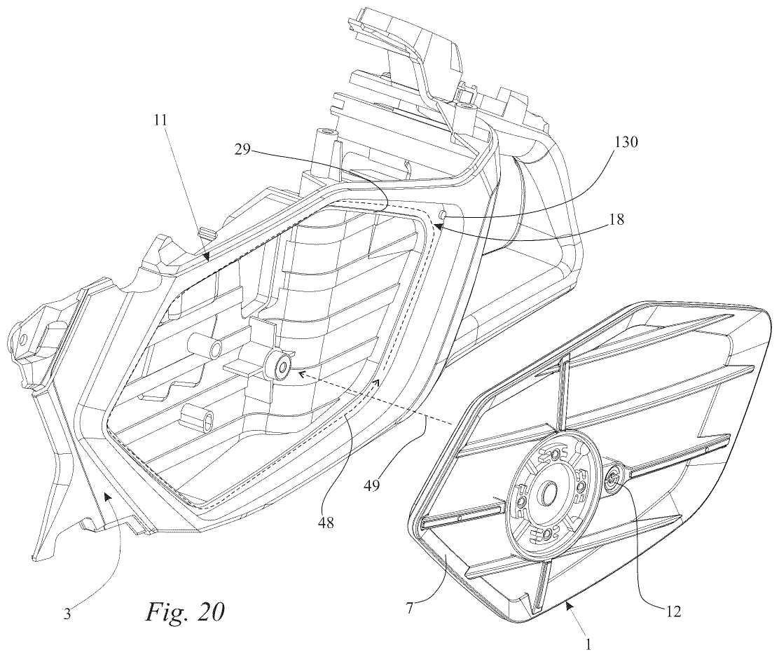

As illustrated in FIGS. 16 to 19 and 22, a sealing element 77 is arranged between the filter component 1, in particular the frame 7 of the filter component 1, and the base body 11. Although FIG. 16 to 23 show an alternative exemplary embodiment, this applies for all exemplary embodiments and is described in more detail below for all exemplary embodiments shown, using the example of the exemplary embodiment of FIG. 16 to 23. The sealing element 77 serves to seal between the base body 11 and the filter component 1, in particular the frame 7 of the filter component 1, against entry or exit of air. The sealing element 77 is made from elastomer, in particular from thermoplastic elastomer. The sealing element 77 circulates, in particular in a closed manner, along a circulation direction 48, illustrated in FIGS. 19 and 20. The through-flow direction 50 and/or the fastening direction 49 runs transverse, in particular perpendicular, to the circulation direction 48. In a view in the through-flow direction 50 and/or in the fastening direction 49, the sealing element 77 circulates in a closed manner around the fastening element 12. The fastening element 12 is arranged approximately in the center of the sealing element 77 that circulates in a closed manner. The sealing element 77 circulates in a closed manner around the through-flow direction 50 and/or the fastening direction 49.

The sealing element 77 can be deformed, in particular elastically deformed, in particular compressed, in particular elastically compressed, between the filter component 1, in particular the frame 7, and the base body 11 in the fastening direction 49. When fastening the filter component 1 to the base body 11, it can be required to exert great pressure on the filter component 1 by means of the fastening element 12, so that the sealing element 77 seals everywhere between the filter component 1, in particular the frame 7, and the base body 11 and a possible distortion of the filter component 1, in particular of the base body 11, is counter-balanced. In order to avoid undesirably great, in particular elastic, compression, in particular deformation, of the sealing element 77, the work apparatus 2 comprises at least one abutment element 130, as illustrated in FIG. 23.

In the exemplary embodiments, the fabric 70 is at least partially, in particular completely made from metal. The frame 7 is made from plastic.

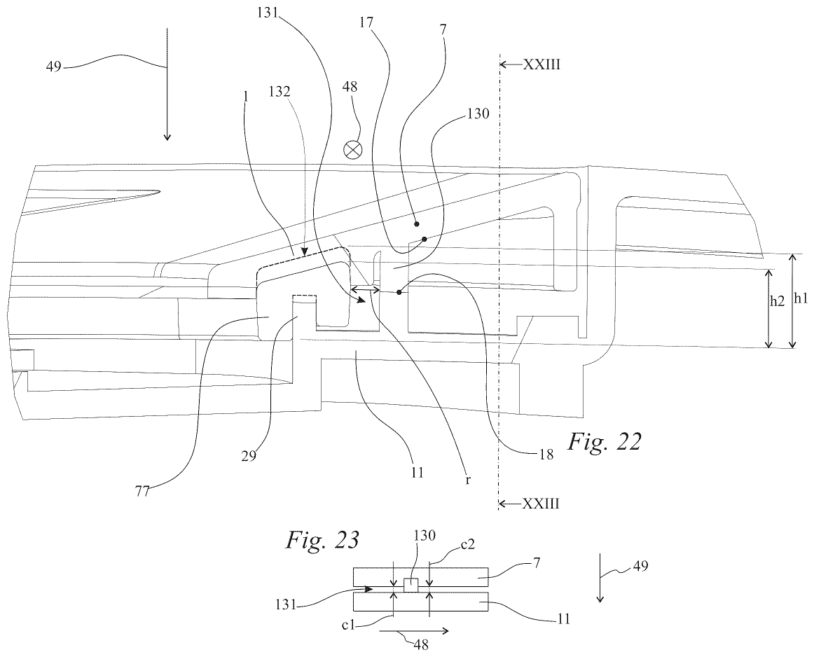

The at least one abutment element 130 is arranged between the base body 11 and the frame 7. The frame 7 is restricted from approaching base body 11 by the abutment element 130 in the fastening direction 49 during the fastening of the filter component 1 to the base body 11. Therefore, undesired deformation, in particular compression, of the sealing element 77 is avoided in the region of the abutment element 130. The abutment element 130 bridges a gap 131 between the base body 11 and the frame 7. In particular, the abutment element bridges the gap 131 locally. The gap 131 is illustrated in FIGS. 22 and 23. The abutment element 130 bridges the gap 131 between the base body 11 and the frame 7, in particular a locally limited manner in relation to the circulation direction 48. In particular, the abutment element 130 only extends over a local subsection of a full circuit, in relation to the circulation direction 48 of the sealing element 77. The subsection corresponds in particular to an angular range of <20° in relation to a circuit around the fastening element 12. In particular, the angular range is >0.5°. In particular, the abutment element 130 bridges the gap 131 between the frame 7 and the base body 11 in such a way that a first distance c1 between the frame 7 and the base body 11, measured in the fastening direction 49, is designed in the circulation direction 48 before the abutment element 130, and that a second distance c2, measured in the fastening direction 49, is designed in the circulation direction 48 after the abutment element 130. In the exemplary embodiment, the first distance c1 and the second distance c2 are identical in size.

In particular, the at least one abutment element 130 limits a, in particular elastic, compression, in particular deformation, of the sealing element 77 in the fastening direction 49. Both the frame 7 as well as the base body 11 are harder than the sealing element 77. The sealing element 77 is elastic. In the exemplary embodiments, the sealing element 77 is a thermoplastic elastomer.

The sealing element 77 has a compression height h2, measured in the fastening direction 49, at a compression point 132, illustrated in FIG. 22, between the frame 7 and the base body 11 in the completely compressed, in particular deformed, state. The sealing element 77 has a sealing element height h2, measured in the same direction 49, at the same compression point 132 in the non-compressed state. The non-compressed state is also referred to as a non-deformed state. In particular, the at least one abutment element 130 limits the compression, in particular deformation, of the sealing element 77 in the fastening direction 49 at the compression point 132 in such a way that the compression height h2 is at least 50%, in particular at least 70%, in particular at least 80%, in particular at least 90%, in particular at least 95%, of the sealing element height h1. It can be provided that the sealing element 77 is compressed, in particular deformed, from the sealing element height h2 to the sealing element height h1 at the compression point 132 when fastening the filter component 1 to the base body 11 by means of the fastening element 12. The abutment element 130 limits the compression, in particular deformation, of the sealing element 77 at the compression point 132 to the compression height h2.

In particular, as can be seen in FIG. 22, the sealing element 77 is substantially U-shaped in a section transverse, in particular perpendicular, to the circulation direction 48. The open end of the U points towards the base body 11 in the fastening direction 49. The two legs of the U engage around a carrier 29 that protrudes towards the filter component 1 in the direction opposite to the fastening direction 49. At least one leg rests on the carrier 29. As illustrated in FIG. 20, the carrier 29 circulates in a closed manner around the fastening element 12 in the circulation direction 48. The sealing element 77 forms a circumferential groove for receiving the carrier 29. For sealing between the frame 7 and the base body 11, it is not required that the groove base of this groove rests on the carrier 29. It is sufficient that at least one of the two groove flanks of the groove rests, in particular in an encircling manner, on the carrier 29.

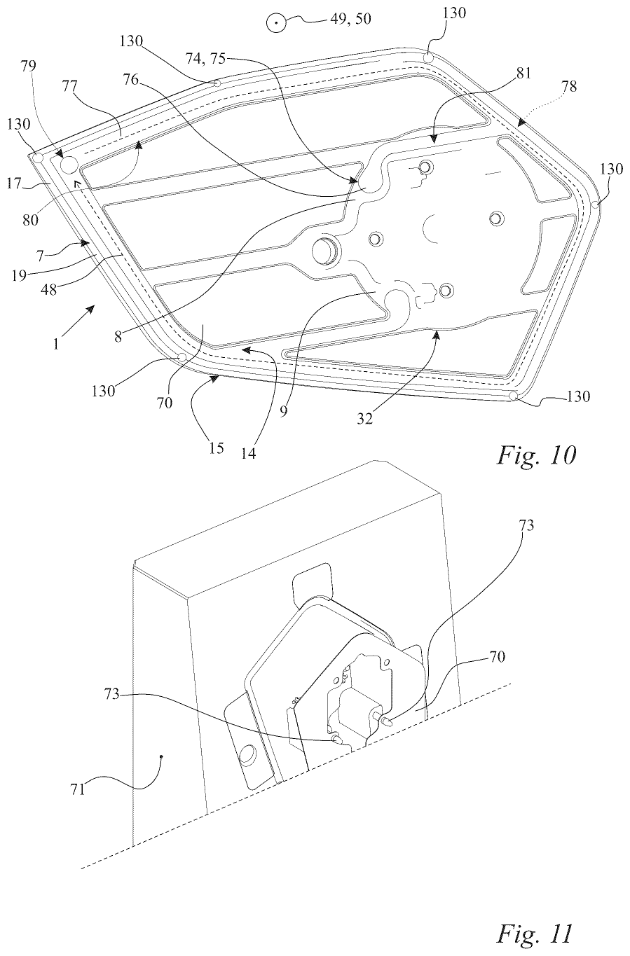

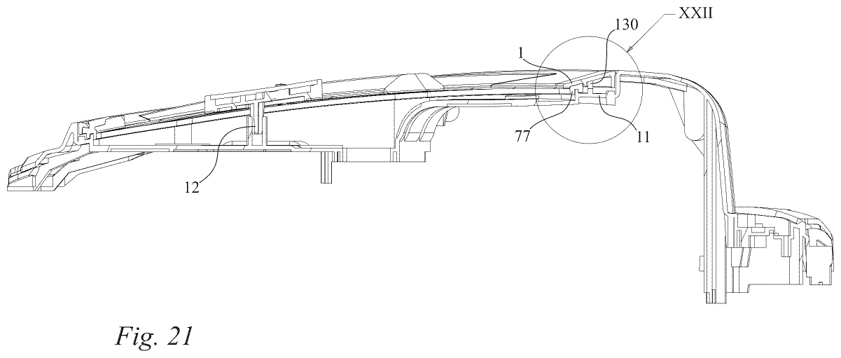

As illustrated in FIG. 10, the frame 7 has a frame edge 17 that circulates, in particular in a closed manner, in the circulation direction 48. As illustrated in FIG. 20, the base body 11 has a base body surface 18 that circulates, in particular in a closed manner, in the circulation direction 48. The base body surface 18 is also referred to as base body ring surface in the exemplary embodiments. In particular, the at least one abutment element 130 protrudes over the frame edge 17 in the fastening direction 49 and/or over the base body surface 18 in the direction opposite to the fastening direction 49. In the exemplary embodiment according to FIG. 10, the at least one abutment element 130 is fixed to the frame 7 of the filter component 1. However, it can also be provided that the at least one abutment element 130 is fixed to the base body 11 of the handheld work apparatus 2 or—as in the exemplary embodiment according to FIGS. 20 and 21—both to the base body 11 and the frame 7. When the at least one abutment element 130 is fixed both to the frame 7 and to the base body 11, the abutment element 130 can be divided.

In the exemplary embodiments, the at least one abutment element 130 is made from the same material as the frame 7, in particular is monolithic therewith. The at least one abutment element 130 is made from the same material as the frame 7. The at least one abutment element 130 is made from plastic.

In the exemplary embodiments, the at least one abutment element 130 is designed as a peg. The peg has a diameter, measured, in particular transverse, in particular perpendicular to the fastening direction 49, in particular perpendicular to the through-flow direction 50. The diameter of the peg is from 1 mm to 6 mm, in particular from 2 mm to 5 mm.

When fastening the filter component 1 to the base body 11, the filter component 1 abuts against the base body 11, in particular the base body surface 18, in the exemplary embodiments with the abutment element 130.

A distance r between the sealing element 77 and the at least one abutment element 130, measured in the direction perpendicular to the fastening direction 49, is smaller than five times, in particular three times, in particular once the sealing element height h1. The distance r is measured in the direction perpendicular to the circulation direction 48. In the exemplary embodiment, the distance r is greater than 10% the sealing element height h1. However, it can also be provided that there is no distance between the sealing element 77 and the at least one abutment element 130.

As illustrated in FIG. 10, in particular at least two, in particular several abutment elements 130 are provided which are spaced apart from each other in relation to the circulation direction 48. In the exemplary embodiment, at least two of the at least two abutment elements 130 have an angular distance of at least 135° to each other, measured in the circulation direction 48. In the exemplary embodiment, overall six abutment elements 130 are provided. In an alternative embodiment, also only one single abutment element 130 can be provided.

During the fastening of the filter component 1 to the base body 11, the filter component 1 is moved closer to the base body 11 in the fastening direction 48 by means of the fastening element 12. In this case, in the exemplary embodiments, the fastening element 12 designed as a screw is screwed into the base body 11. The frame 7 is restricted from approaching the base body 11 by the at least one abutment element 130 in relation to the fastening direction 48 during the fastening of the filter component 1 to the base body 11.

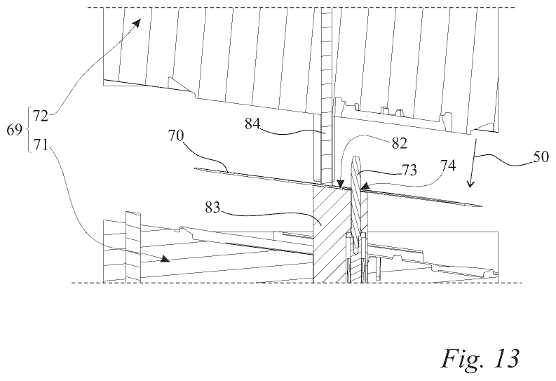

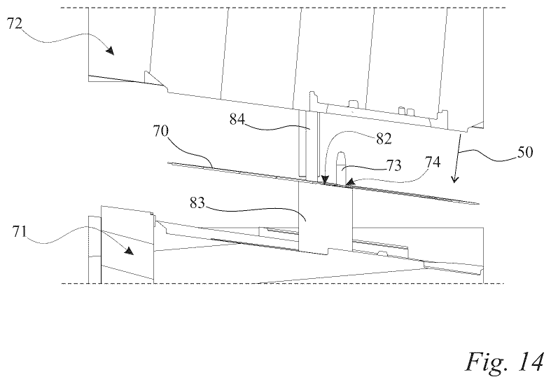

The filter component 1 according to FIG. 10 is produced in a casting tool 69, in particular in an injection molding tool, illustrated in FIG. 11 to 15 (in particular FIG. 13). Initially, a sample filter component without abutment elements 130 is produced in the casting tool 69. The sample filter component is fastened to the base body 11 of the work apparatus 2, in order to establish at which point and in which form the at least one abutment element 130 is required. Subsequently, the casting tool 69 is modified so that with the subsequent production of the filter component 1, the at least one abutment element 130 is created during a casting step, in particular an injection molding step, in the modified casting tool 69. Subsequently, the modified casting tool 69 for producing further filter components 1 is used. Renewed modification of the casting tool 69 is not required. A single modification of the casting tool 69 is sufficient to subsequently produce many more filter components 1. The filter components 1 then adapt to the base body 11, which were all produced with the same base body casting tool, to which the modified casting tool 69 is adapted.

There can be modification of the casting tool 69 can consist in the milling out of a recess in the casting tool 69, in particular in one of the two or both of the tool halves 71 and 72 of the casting tool 69 and/or in the application of a projection to the casting tool 69, in particular to one of the two or both tool halves 71 and 72 of the casting tool 69. Modifications can be provided at several points.

As illustrated in FIG. 1, the tool 10, in particular the guide bar 21, has a longitudinal center axis 13. In the exemplary embodiment, the longitudinal center axis 13 is arranged between the at least two connecting ribs 8 and 9, in a view in the through-flow direction 50 of the cooling air. In the exemplary embodiment, the longitudinal center axis 13 is arranged between the connecting rib 8 and the connecting rib 9, in a view in the through-flow direction 50 of the cooling air.

According to the alternative exemplary embodiments according to those in FIG. 16 to 23, the filter component 1 comprises a gauge element 110. The gauge element 110 is provided as a gauge for aligning the work apparatus 2, in particular for aligning the tool 10 of the work apparatus 2, in particular the guide bar 21. With the filter component 1 mounted on the base body 11, the gauge element 110 is arranged at a distance from the tool 10. Even when the tool 10 is concealed, for example by a workpiece or put in a workpiece to be machined, the orientation and position of the tool 10 can be determined by the gauge element 110. The gauge element 110 is part of the outer side 3 of the work apparatus 2. The gauge element 110 is arranged on the frame 7 of the filter component 1.

The gauge element 110 and the sealing element 77 are made from the same material. The gauge element 110 and the sealing element 77 are designed to be monolithic with each other as a gauge and sealing element 111. In particular this can be seen in FIG. 19. The gauge element 110 and the sealing element 77 are designed contiguously to each other as a gauge and sealing element 111. The gauge element 110 and the sealing element 77 are produced together in a single method step, in particular a casting step, in particular an injection molding step.

Both the gauge element 110 as well as the sealing element 77 are made from a thermoplastic elastomer.

As illustrated in FIG. 17, the filter component 1 has an inner side 14 facing towards the base body 11 in the installed position of the filter component 1, and an outer side 15 facing away from the base body 11 in the installed position of the filter component 1. At least one through-flow opening 16 completely penetrates the filter component 1 from the inner side 14 to the outer side 15. The position of the at least one through-flow opening 16 is marked schematically in FIG. 16 with a dotted circular line. The through-flow opening 16 completely penetrates the filter component 1, in particular the frame 7 of the filter component 1 in the through-flow direction 50. During a casting step, in particular during an injection molding step, in particular during a plastic injection molding step, material, in particular plastic can flow through the through-flow opening 16. At least two through-flow openings 16 are provided, in the exemplary embodiments four through-flow openings 16.

The gauge and sealing element 111 extends through the through-flow opening 16. The gauge and sealing element 111 completely fills the through-flow opening 16.

As illustrated in FIGS. 17 and 18, the frame 7 has a duct 80 for receiving the sealing element 11 on the inner side 14 of the filter component 1. The frame 7 has a gauge element duct 114 for receiving the gauge element 110 on the outer side 15 of the filter component 1. The duct 80 has the form of a groove. During the injection molding step, the open longitudinal side of the groove of the duct 80 is facing towards a second tool half 72 of the casting tool 69, illustrated in FIG. 13. The gauge element duct 114 has the form of a groove. During the injection molding step, the open longitudinal side of the groove of the gauge element duct 114 is facing towards a first tool half 71 of the casting tool 69, illustrated in FIG. 13.

The through-flow opening 16 connects the duct 80 and the gauge element duct 114 to each other. During the casting step, in particular during the injection molding step, in particular during the plastic injection molding step, the material, in particular plastic, can flow through the gauge element duct 114 on the outer side 15 of the filter component 1 to the through-flow opening 16 and through the through-flow opening 16 into the duct 80 on the inner side 14 of the filter component 1. The through-flow opening 16 is a connecting hole in the frame 7 for connecting the inner side 14 to the outer side 15. The gauge element 110 and the sealing element 77 are cast in a single casting step, in particular a single injection molding step, in particular a single plastic injection molding step. In the process, the gauge and sealing element 111 is formed. In particular, the gauge and sealing element 111 is designed monolithically in this case.

The gauge element duct 114 has a duct width k, measured in particular in the direction perpendicular to the fastening direction 49, in particular to the through-flow direction 50, as illustrated in FIG. 19. The through-flow opening 116 has a diameter d, illustrated in FIG. 18 or 17. The diameter d is measured in particular in the direction perpendicular to the fastening direction 49, in particular to the through-flow direction 50. In the exemplary embodiments, the diameter d of the through-flow opening 116 is at least 60%, in particular at least 70%, in particular at least 80%, of the duct width k. In particular, the diameter d of the through-flow opening is at least 0.5 mm, in particular at least 1 mm. Therefore, the through-flow opening 116 is large enough that the material can flow through it well. In particular, the diameter d of the through-flow opening 116 is at most 4 mm, in particular at most 3 mm. Therefore, the through-flow opening 116 is small enough in order to be able to fill it well using very little material.

The gauge element 110 is arranged on the outer side 15 of the filter component 1. The sealing element 77 is arranged on the inner side 14 of the filter component 1. The base body 11 and the gauge element 110 contrast in color. The base body 11 has a different color on its outer side 3 than the gauge element 110. The frame 7 and the gauge element 110 contrast with each other. The frame 7 has a different color at the point directly adjacent to the gauge element 110 than the gauge element 110. In particular, the gauge element 110 is one color. In particular, the frame 7 is one color.

The tool 10 has a longitudinal extension. The longitudinal extension of the tool 10 runs along the longitudinal center axis 13 of the tool 10, in particular the guide bar 21. The gauge element 110 has a piercing guide 112 and/or a felling guide 113. In the exemplary embodiment, the gauge element 110 has both a piercing guide 112 as well as a felling guide 113. The piercing guide 112 extends substantially in the direction of the longitudinal extension, in particular in the direction of the longitudinal center axis 13, in the installed position of the filter component 1. The felling guide 113 extends in a direction transverse, in particular perpendicular, to the direction of the longitudinal extension, in particular to the direction of the longitudinal center axis 13, in the installed position of the filter component 1. This applies in particular for a view of the work apparatus 2 in the through-flow direction 50. In particular, this applies for a view perpendicular to the tool plane of the tool 10.

The piercing guide 112 has in particular on first piercing guide section 115 and a second piercing guide section 116. The first piercing guide section 115 and the second piercing guide section 116 are designed in particular spaced apart from each other in a view in the through-flow direction 50.

The felling guide 113 has in particular one first felling guide section 117 and one second felling guide section 118. The first felling guide section 117 and the second felling guide section 118 are designed in particular spaced apart from each other in a view in the through-flow direction 50.

The materially uniform, in particular monolithic, design of the piercing guide 112 of the gauge element 110 and the felling guide 113 of the gauge element 110 cannot be seen on the outer side 15 of the filter component 1. In a view of the outer side 15 of the filter component 1 in the through-flow direction 50, it appears as if the felling guide 113 and the piercing guide 112 are components that are designed separately from each other. A connection between the piercing guide 112 and the felling guide 113 cannot be seen from the outside. The piercing guide 112 and the felling guide 113 are arranged in such a way that the materially uniform, in particular monolithic design of the piercing guide 112 of the gauge element 110 and the felling guide 113 of the gauge element 110 cannot be seen on the outer side 15 of the filter component 1. The piercing guide 112 and the felling guide 113 are arranged in such a way that they appear separated from each other by concealing areas, in particular by the frame 7.

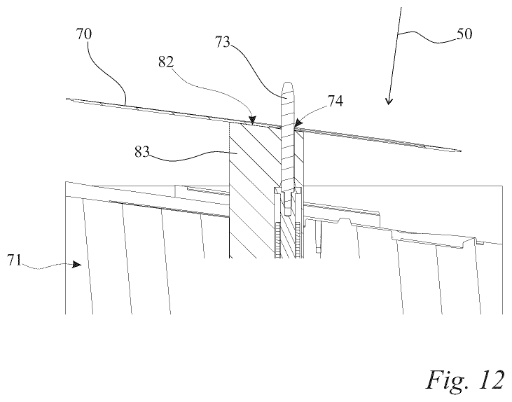

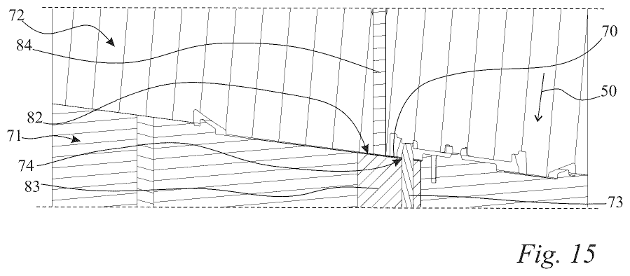

When producing the filter component 1, for all exemplary embodiments, the fabric 70 is cast in a casting step between the first tool half 71 and the second tool half 72 such that the frame 7 is created in the process. FIG. 12 to 15 exclusively show for the exemplary embodiment according to FIG. 10 the positioning of the fabric 70 between the first tool half 71 and the second tool half 72. In the position, illustrated in FIG. 15, the fabric 70 is held clamped between the first tool half 71 and the second tool half 72. The pin 73 completely penetrates the fabric 70 in the direction from the first tool half 71 and the second tool half 72. During the casting step, a holding opening 75, completely penetrating the frame 7 in the direction from the first tool half 71 and the second tool half 72, is created where the pin 73 is located in the frame 7. The position of the holding opening 75 is marked in FIG. 10. In particular, the pin 73, which holds the fabric 70 in position during the casting step, penetrates the fabric 70 at a point, which is over-molded during the casting step in such a way that the frame 7 is created at this point, or around this point. To penetrate the fabric 70 with the pin 73, the fabric 70 has a through opening 74. In the exemplary embodiment according to FIG. 10, the holding opening 75 completely penetrates the frame 7 in the through-flow direction 50. In the alternative exemplary embodiment according to FIG. 25, no holding opening 75 is created at all.

In both cases, the filter component 1 comprises a blocking element, by which cooling air is prevented from flowing through the filter component 1 in the through-flow direction 50 in the region of the through opening.

In the exemplary embodiment according to FIG. 10, the through opening 74, in particular the holding opening 75, is sealed in the frame 7 in a sealing step, following the casting step, with a closure element 76 made from elastomer. In this case, the blocking element is the closure element 76. In particular, the closure element 76 is made from a thermoplastic elastomer. The through opening 74 completely penetrates the fabric 70 in the direction from the first tool half 71 towards the second tool half 72, in particular in the direction opposite to the through-flow direction 50. During the casting step, the pin 73 is guided through the through opening 74.

During the casting step, the fabric 70 can be non-detachably threaded on the pin 73 with the through opening 74. During the casting step, the pin 73 contacts both the first tool half 71 as well as the second tool half 72. Movement of the fabric 70 in the direction of the penetrating direction 50, or counter thereto, is limited by the first tool half 71 or by the second tool half 72. The fabric 70 cannot be removed from the pin 73.

In all exemplary embodiments, the fabric 70 is resistant to bending. In particular, the fabric 70 is self-supporting. The fabric 70 is dimensionally stable when supported at one point.

In all exemplary embodiments, the frame 7 is produced in the casting step by means of an injection molding method, in particular by means of a plastic injection molding method.

The filter component 1 comprises a connecting structure 32, illustrated in FIG. 10. The connecting structure 32 connects at least two opposite points of the circumferential frame 19 of the frame 7 to each other. The connecting structure 32 is a component of the frame 7. The connecting structure 32 comprises the connecting rib 8 and the connecting rib 9. In the exemplary embodiment according to FIG. 10, the holding opening 75 is provided in the connecting structure 32. In particular a second holding opening is provided in the connecting structure 32. The through opening 74 is also arranged at the place of the holding opening 75. For all exemplary embodiments with the through opening, the through opening 74 is arranged at a distance from the circumferential frame 19. In this case, the distance is measured perpendicular to the fastening direction 49, in particular perpendicular to the through-flow direction 50. The through opening 74 is arranged in the surface of the fabric 70 at a distance from the edge 78 of the fabric 70, measured in the direction perpendicular to the through-flow direction 50, in particular to the fastening direction 49. In particular, the through opening 74 is arranged in the center of the filter component 1, in particular in the center of the fabric 70, in a side view perpendicular to the tool plane of the tool 10 (FIG. 1, not shown here however). In particular, in this side view the through opening 74 is arranged close to the centroid of the surface assigned to the filter outer contour 28.

As shown by a comparison of FIGS. 13, 14, and 15, after threading the fabric 70, in all embodiments with a through opening on the pin 73, the fabric 70 is moved together with a support element 83, on the support surface 82 of which the fabric 70 is placed, and the second tool half 72 is moved towards the first tool half 72, so that at the end the fabric 70 rests both against the first tool half 71 as well as the second tool half 72. When the first tool half 71 and the second tool half 72 move towards each other, the distance of the abutment element 83 from the first tool half 71 is reduced so much that it finally disappears. In an analogous manner, the holding element 84 disappears into the second tool half 72 when the first tool half 71 and the second tool half 72 move towards each other. The second holding element 84 no longer projects from the second tool half 72 at.

In all exemplary embodiments, in the casting step the fabric 70 is recast with the frame 7. In the exemplary embodiment according to FIG. 10, the holding opening 75 in the frame 7 is created hereby. After the casting step, the holding opening 75 is sealed with the closure element 76. The closure element 76 is cast while the frame 7 and the fabric 70 are located between the first tool half 71 and the second tool half 72. The fabric 70, in particular the filter component 1, is located, between the casting step and the sealing step in all exemplary embodiments, uninterrupted between the first tool half 71 and the second tool half 72.

In all exemplary embodiments, the sealing element 77 is produced in the sealing step. Firstly, in the casting step, plastic is introduced into the casting tool 69. Only thereafter is an elastomer, in particular a thermoplastic elastomer, introduced into the casting tool 69. The sealing element 77 is thereby produced.

For the exemplary embodiment according to FIG. 10, the sealing element 77 and the closure element 76 are cast in a single casting step. The sealing element 77 and the closure element 76 are made from the same material, in particular are monolithic with each other. The holding opening 75 in the frame 7 serves to vent air displaced by the material for producing the sealing element 77, during the pouring of the material for producing the sealing element 77, during the sealing step. This applies for the exemplary embodiment according to FIG. 10.

In all exemplary embodiments, the frame 7 has a feed opening 79 for pouring in the material for producing the sealing element 77, as illustrated in FIG. 10 by way of example. In the exemplary embodiments, the material for producing the sealing element 77, in particular for producing the gauge and sealing element 111 is applied on the outer side 15 of the filter component 1 to the filter component 1, in particular to the frame 7. Both the material for producing the frame 7, in particular the plastic material, as well as the material for producing the sealing element 77, in particular the gauge and sealing element 111, in particular the thermoplastic elastomer, is applied on the same side of the filter component 1, in particular of the frame 7, in particular on the outer side 15. Therefore, a simple design of the respective casting tool is possible.

In the exemplary embodiment according to FIG. 10, the material for producing the sealing element 77 reaches through from the outer side 15 to the inner side 14 into the duct 80 through the feed opening 79. The material flows into the duct 80 and forms the sealing element 77 in the duct 80. In the process, the material, in particular the thermoplastic elastomer, displaces air. This air can escape through the holding opening 75 in the frame 7. As described above, the duct 80 for receiving the sealing element 77 extends along the edge of the frame 7. The duct 80 circulates in a closed manner in the circumferential direction 80. The holder opening 75 is arranged at a distance from the edge of the frame 7. The duct 80 and the holder opening 75 are connected to each other via a connecting duct 81 of the frame 7. The connecting duct 81 extends from the duct 80 to the holder opening 75. The connecting duct 81 is arranged in the connecting rib 8. In the exemplary embodiment, similarly a connecting duct 81 is arranged in the connecting rib 9. The duct 80 and the connecting duct 81 are arranged on the inner side 14 of the filter component 1. The holding opening 75 completely penetrates the frame 7 originating from its inner side 14 towards the outer side 15 in the direction opposing the through-flow direction 50. When producing the filter component 1, in particular during the sealing step, the inner side 14 of the filter component 1 is facing towards the first tool half 71. During the preceding casting step, both the duct 80 as well as the connecting duct 81 are filled by a component of the first tool half 71. This creates firstly the duct 80 and also the connecting duct 81. During the casting step, a cavity is designed between the first tool half 71 and the duct 80, and also between the first tool half 71 and the connecting duct 81. In the exemplary embodiment, this cavity is made available in that place holders, which project in the direction of the fabric 70 during the casting step, are removed from the first tool half 71 or retracted into the first tool half 71. Therefore, space is created for the material, which flows into the duct 80 to produce the sealing element 77. Similarly, space is created for the material, which flows through the connecting duct 81 into the holding opening 75 and thereby completely fills the holding opening 75, thereby creating the closure element 76. In this case, the air displaced by the material for producing the sealing element 77 and the closure element 76 can escape to the outer side 15 of the filter component 1. In the sealing step, therefore the duct 80 and the connecting duct 81 can continue to be covered, in particular in an airtight manner, by the first tool half 71. The displaced air can flow over the path through the space of the duct 80 of the connecting duct 81, not yet filled by the material for producing the sealing element 77, to the holding opening 75 and can escape to the outer side 15 of the filter component 1. Therefore, simple venting of the duct 80 and the connecting duct 81 is possible during the sealing step. Both the sealing element 77 as well as the closure element 76 can be produced in a single casting step in a simple manner. In this casting step, both the sealing element 77 as well as the closure element 76 is produced from a thermoplastic elastomer. The holding opening 75 is subsequently sealed with the closure element 76 made from an elastomer, in particular from a thermoplastic elastomer.

In the exemplary embodiment according to FIG. 16 to 23, the venting takes place in another manner during the sealing step. The position of the feed opening 79 is marked in FIG. 16 and FIG. 19. Said feed opening is located above the gauge element duct 114, in particular above the duct for forming the piercing guide 112. Originating from the feed opening 79, the material for producing the gauge and sealing element 111 flows in two directions in the gauge element duct 114, in particular in the duct for forming the piercing guide 112. One direction leads away from the circumferential frame 19, the other direction leads to the circumferential frame 19 and to the through-flow opening 16 (FIG. 19). The material reaches from the outer side 15 of the filter component 1, in particular of the frame 7, to the inner side 14 of the filter component 1, in particular of the frame 7, through the through-flow opening 16 (FIGS. 17 and 18). On the inner side 14 of the filter component 1, in particular the frame 7, the material flows through the duct 80 and thereby forms the sealing element 77 as a part of the sealing and gauge element 111. The material reaches from the duct 80 to the inner side 14 again to the outer side 15 through a further through-flow opening 16 and flows there in the duct to form the felling guide 113. The duct for forming the felling guide 113 and the duct for forming the piercing guide 112 are both a component of the gauge element duct 114. The duct for forming the felling guide 113 and the duct for forming the piercing guide 112 are designed separately from each other. The direction of the longitudinal extension of the duct for forming the felling guide 113 runs transverse, in particular perpendicular, to the direction of the longitudinal extension of the duct for forming the piercing guide 112, in particular in the view in the direction of the through-flow direction 50. In a view in the direction of the through-flow direction 50, imaginary extending lines of the duct for forming the felling guide 113 and the duct for forming the piercing guide 112 intersect orthogonally. At the end of the duct for forming the felling guide, a further through-flow opening is designed, this time from the outer side 15 to the inner side 14. Based on this, venting for the material expanding from the feed opening 79 takes place in the direction towards the circumferential frame 19. Venting through a further through-flow opening takes place in the other direction from the outer side 15 to the inner side 14 at the end of the duct for forming the piercing guide 112.

In an embodiment, alternatively to the embodiment according to FIG. 10, the blocking element, by which cooling air is prevented from flowing through the filter component 1 in the through-flow direction 50 in the region of the through opening 74, is formed in a different manner to being formed by a closure element 76. FIG. 25 schematically shows a corresponding filter component 1. It is common to all embodiments that the through opening 74, in particular an edge of the through opening 74, is surrounded by material of the frame 7. In FIG. 10, the through opening 74 is surrounded by the holding opening 75, which is formed by the frame. In the exemplary embodiment according to FIG. 25, the through opening 74 is surrounded by the frame 7 in the direction perpendicular to the through-flow direction, in particular in the radial direction.

The through opening 74 is covered by the connecting structure 32. The connecting structure 32 connects at least two points of the circumferential frame 19 to each other in all exemplary embodiments. In relation to this connection, the connecting structure 32 for the exemplary embodiment according to FIG. 25 is designed analogous to the connecting structure 32 illustrated in FIG. 10.

In the exemplary embodiment according to FIG. 25, the blocking element is an overlap section 33. The overlap section 33 is marked in FIG. 25 with a dashed line. The overlap section 33 is located only in the region in the direction of the through-flow direction 50 or in the direction opposed to the through-flow direction 50 above or below the through opening 74. The overlap section 33 is only arranged in the region of a projection of the through opening 74 in the through-flow direction 50 or in the direction opposed to the through-flow direction 50. In the exemplary embodiment, the overlap section 33 is formed by a section of the frame 7.

The blocking element conceals the through opening 74 in all exemplary embodiments, when viewed in the direction of the through-flow direction 50. In the exemplary embodiment according to FIG. 25, the overlap section 33 completely covers the through opening 74. In contrast to the closure element 76, the overlap section 33, in particular in relation to the through-flow direction 50, is spaced apart from the through opening 74, in particular from the fabric 70. The blocking element covers the through opening 74 like a hood, in the exemplary embodiment according to FIG. 25.

The frame 7 has a frame thickness s1 measured in the through-flow direction 50 in the region around the through opening 74. The frame thickness s1 is measured adjacent to the overlap section 33. The frame thickness s1 is measured adjacent to the through opening 74, in particular adjacent to the edge of the through opening 74, in particular to the edge of the through opening 74. The overlap section 33 has an overlap thickness s2 measured in the through-flow direction 50. The overlap thickness s2 corresponds to the largest extent of the overlap region 33 in the direction of the through-flow direction 50. In the exemplary embodiment, the overlap thickness s2 is measured adjacent to the through opening 74, in particular to the edge of the through opening 74. The overlap section 33 has a minimum overlap thickness s3 measured in the through-flow direction 50. The minimum overlap thickness s3 corresponds to the smallest extent of the overlap region 33 in the direction of the through-flow direction 50. The minimum overlap thickness s3 is measured in particular above the through opening 74, in the exemplary embodiment in the center of the through opening 74.

The overlap thickness s2 is at most 50%, in particular at most 20%, in particular at most 5% of the frame thickness s1.

The overlap thickness s2 is at least 1% of the frame thickness s1.

The overlap thickness s2 is from 0.01 mm to 5 mm, in particular from 0.05 mm to 2 mm.

In the exemplary embodiment according to FIG. 25, the blocking element is formed by the material of the frame 7.

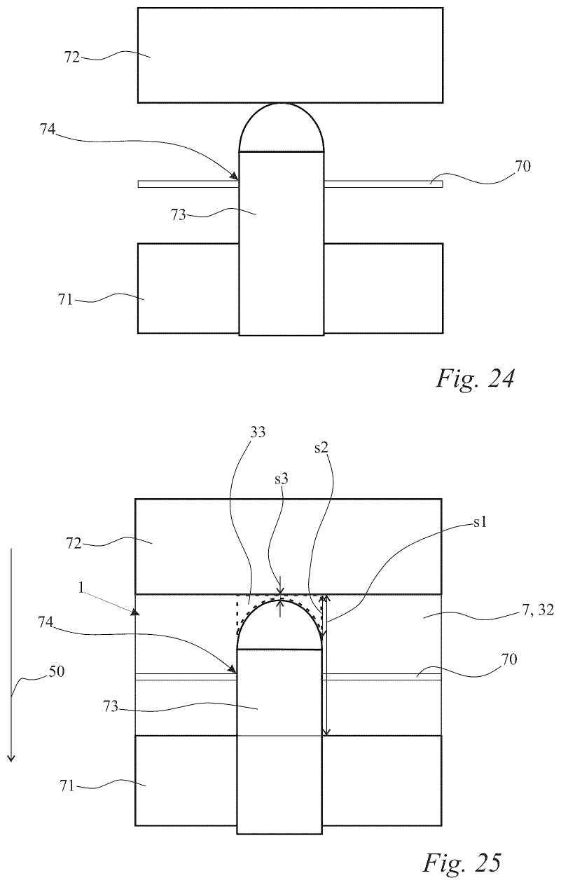

FIGS. 24 and 25 show an alternative casting tool with a first tool half 71 and a second tool half 72. The alternative casting tool serves to produce the filter component 1 in an alternative embodiment according to FIG. 25. The alternative casting tool comprises a first tool half 71, a second tool half 72 and at least one pin 73.

When producing the alternative filter component 1, the fabric 70 is cast in a casting step between the first tool half 71 and the second tool half 72 such that the frame 7 is created thereby. The at least one pin 73 is guided through the through opening 74 during the casting step, in order to hold the fabric 70 in position. Cooling air is prevented from flowing through the filter component 1 in the through-flow direction 50 in the region of the through opening 74 by the provision of a blocking element. The blocking element is hereby formed during the casting step by the frame 7.

The material for producing the frame 7 penetrates into the region between the pin 73 and the alternative casting tool during the casting step. At the beginning of the casting step, the pin 73 can rest both against the first tool half 71 as well as the second tool half 72 of the alternative casting tool. During the casting step, the pin 73 is removed from the second tool half 72. In the exemplary embodiment, this occurs because of the pressure of the material for producing the frame 7. Alternatively, the pin 73 can also be arranged at a distance from the second tool half 72. This distance can in particular already exist at the beginning of the casting step. In particular, the distance is unchangeable during the casting step. In particular, the distance is from 1 mm to 20 mm, in particular from 1 mm to 10 mm, in particular from 1 mm to 3 mm. However, other values can also be provided for the distance. The distance is measured in particular in the through-flow direction 50.

The pin 73 is pretensioned with a tension force in the direction of the second tool half 72, for example by means of a spring (not shown). The tension force and the pressure, with which the material for producing the frame 7 is introduced during the casting step, are matched to each other, so that the pin 73 is removed from the second tool half 72 by the material for producing the frame 7 counter to the direction of the tension force during the casting step. The material for producing the frame 7 penetrates into the space between the second tool half 72 and the pin 73. Therefore, the blocking element, in particular the overlap section 33 is formed, as illustrated in FIG. 25. The through opening 74 of the fabric 70 is in particular not filled by material for producing the frame 7.

Further aspects of the invention include:
Aspect A1: Filter component for filtering cooling air for a handheld work apparatus 2, wherein the filter component 1 is provided to form a part of an outer side 3 of the work apparatus 2, characterized in that the filter component 1 has thick thread elements 4 and thin thread elements 5, that the cooling air has to pass through both the thin thread elements 5 as well as the thick thread elements 4 for filtering the cooling air, that the thick thread elements 4 and the thin thread elements 5 are each thread-like, that the diameter d1 of the thick thread elements 4 is greater than the diameter d2 of the thin thread elements 5, and that the thick thread elements 4 serve to support the thin thread elements 5.
Aspect A2: Filter component according to aspect A1,
   characterized in that
      the thick thread elements 4 are in their own right interwoven to form a supporting fabric 20 and the thin thread elements 5 are in their own right interwoven to form a filter fabric 30,
   or
      the thick thread elements 4 and the thin elements 5 are interwoven together to form a single supporting filter fabric 40.
Aspect A3: Filter component according to aspect A1,
   characterized in that
      the thick thread elements 4 are in their own right interlaced to form a supporting fabric 20 and the thin thread elements 5 are in their own right interlaced to form a filter fabric 30,
   or
      the thick thread elements 4 and the thin elements 5 are interlaced together to form a single supporting filter fabric 40.
Aspect A4: Filter component according to aspect A2 or A3,
   characterized in that the filter fabric 30 is supported, in particular directly, on the supporting fabric 20 during operation of the filter component 1.
Aspect A5: Filter component according to one of aspects A2 to A4,
   characterized in that the supporting fabric 20 is provided for arrangement in the work apparatus 2 so that it forms a part of the outer side 3 of the work apparatus 2 and that the filter fabric 30 is facing towards an inner region 6 of the work apparatus 2 or,
   that the filter fabric 30 is provided for arrangement in the work apparatus 2 so that it forms a part of the outer side 3 of the work apparatus 2 and that the supporting fabric 20 is facing towards an inner region 6 of the work apparatus 2.
Aspect A6: Filter component according to one of aspects A2 to A5,
   characterized in that the filter component comprises a further supporting fabric 60, and that the filter fabric 30 is arranged between the supporting fabric 20 and the further supporting fabric 60.
Aspect A7: Filter component according to one of aspects A2 to A6,
   characterized in that a supporting mesh size a1 of the supporting fabric 20 is greater than a filter mesh size a2 of the filter fabric 30.
Aspect A8: Filter component according to one of aspects A2 to A7,
   characterized in that the filter component 1 has a frame 7, which delimits a structural unit made from the filter fabric 30 and the supporting fabric 20 from both sides in relation to a through-flow direction 50 of the cooling air, and in particular that the frame 7 is injection molded around the filter fabric 30 and the supporting fabric 20 by means of injection molding.
Aspect A9: Filter component according to aspect A2,
   characterized in that the thick thread elements 4 and the thin thread elements 5 are interwoven to form a Dutch weave.
Aspect A10: Filter component according to one of aspects A1 to A9,
   characterized in that the thick thread elements 4 and/or the thin thread elements 5 are made from metal, in particular from corrosion-resistant metal, in particular from stainless steel.
Aspect A11: Filter component according to one of aspects A1 to A10,
   characterized in that the filter component 1 has at least two connecting ribs 8, 9, that the connecting ribs 8, 9 are arranged on the thin thread elements 5 and/or the thick thread elements 4 and are provided for arranging on the outer side of the work apparatus.
Aspect A12: Filter component according to aspect A11,
   characterized in that the at least two connecting ribs 8, 9 enclose at least one part of the thick thread elements 4 and one part of the thin thread elements 5 from both sides in relation to the through-flow direction 50 of the cooling air.
Aspect A13: Handheld work apparatus having a filter component according to one of aspects A1 to A12,
   characterized in that the filter component 1 forms a part of an outer side 3 of the work apparatus 2, and that cooling air can flow through the filter component 1 in a through-flow direction 50 from the outside into an inner region 6 of the work apparatus 2.
Aspect B1: Filter component for filtering cooling air for a handheld work apparatus 2, wherein the filter component 1 comprises a frame 7 and a fabric 70, wherein the filter component 1 is provided for cooling air to flow through in a through-flow direction 50,
   wherein the frame 7 encloses the fabric 70 from both sides in relation to the through-flow direction 50 and circulates in a closed manner around the through-flow direction 50, wherein the fabric 70 has a through opening 74 penetrating the fabric 70 completely in the through-flow direction 50 for feeding-through a pin 73 during production of the filter component 1,
   characterized in that the filter component 1 comprises a blocking element, and that cooling air is prevented from flowing through the filter component 1 in the through-flow direction 50 in the region of the through opening 74 by the blocking element.
Aspect B2: Filter component according to aspect B1,
   characterized in that the through opening 74, in particular an edge of the through opening 74, is surrounded by the material of the frame 7.
Aspect B3: Filter component according to aspect B1 or B2,
   characterized in that the frame 7 comprises a circumferential frame 19 and at least one connecting structure 32, that the circumferential frame 19 circulates around an edge 78 of the fabric 70, that the connecting structure 32 connects two opposite points of the circumferential frame 19 to each other, and that the through opening 74 is arranged in the region of the connecting structure 32, in particular at a distance from the circumferential frame 19.
Aspect B4: Filter component according to aspect B3,
   characterized in that the through opening 74 is covered by the connecting structure 32.
Aspect B5: Filter component according to one of aspects B1 to B4,
   characterized in that the blocking element is an overlap section 33, which covers, in particular completely covers, the through opening 74.
Aspect B6: Filter component according to aspect B5,
   characterized in that the frame 7 has a frame thickness s1, measured in the through-flow direction 50, in the region around the through opening 74, that the overlap section 33 has an overlap thickness s2, measured in the through-flow direction 50.
Aspect B7: Filter component according to aspect B6,
   characterized in that the overlap thickness s2 is at most 50%, in particular at most 20%, in particular at most 5%, of the frame thickness s1.
Aspect B8: Filter component according to aspect B6 or B7,
   characterized in that the overlap thickness s2 is from 0.01 mm to 5 mm, in particular from 0.05 mm to 2 mm.
Aspect B9: Filter component according to one of aspects B1 to B8,
   characterized in that the blocking element is formed by material of the frame 7.
Aspect B10: Filter component according to one of aspects B1 to B3,
   characterized in that the through opening 74 is sealed with a closure element 76 made from elastomer, in particular from thermoplastic elastomer.
Aspect B11: Method for producing a filter component for filtering cooling air for a handheld work apparatus 2, wherein the filter component 1 comprises a frame 7 and a fabric 70, wherein the filter component 1 is provided for cooling air to flow through in a through-flow direction 50, wherein the frame 7 encloses the fabric 70, wherein the fabric 70 is over-molded between a first tool half 71 and a second tool half 72 in a casting step during production of the filter component 1, thereby creating the frame 7, wherein the fabric 70 has a through opening 74, wherein at least one pin 73 is guided through the through opening 74 during the casting step in order to hold the fabric 70 in position,
   characterized in that cooling air is prevented from flowing through the filter component 1 in the through-flow direction 50 in the region of the through opening 74 by the provision of a blocking element, and in particular that the blocking element is formed by the frame 7.
Aspect C1: Handheld work apparatus comprising a base body 11 and a filter component 1 for filtering cooling air, wherein the filter component 1 can be fastened to the base body 11 in relation to a fastening direction 49 by means of the fastening element 12, wherein the filter component 1 has a frame 7, wherein the filter component 1 has a sealing element 77, circulating along a circulation direction 48, for sealing between the frame 7 and the base body 11, wherein the sealing element 77 is arranged in the fastening direction 49 between the frame 7 and the base body 11,
   characterized in that the work apparatus 2 comprises at least one abutment element 130 between the base body 11 and the frame 7, that the frame 7 is restricted from approaching the base body 11 by the abutment element 130 in the fastening direction 49 during the fastening of the filter component 1 to the base body 11.
Aspect C2: Handheld work apparatus according to aspect C1,
   characterized in that the at least one abutment element 130 limits deformation of the sealing element 77 in the fastening direction 49.
Aspect C3: Handheld work apparatus according to aspect C2,
   characterized in that the sealing element 77 has a compressed height h2, measured in the fastening direction 49, at a compression point 132 between the frame 7 and the base body 11 in the completely compressed state, that the sealing element 77 has a sealing element height h1, measured in the same direction, at the same compression point 132 in the non-compressed stated, and that the at least one abutment element 130 limits the compression of the sealing element 77 in the fastening direction 49 at the compression point 132, in such a way that the compression height h2 is at least 50%, in particular at least 80%, in particular at least 90%, of the sealing element height h1.
Aspect C4: Handheld work apparatus according to one of aspects C1 to C3,
   characterized in that the frame 7 has a frame edge 17, circulating in the circulation direction 48, and/or that the base body 11 has a base body surface 18, circulating in the circulation direction 48, and that the at least one abutment element 130 projects beyond the frame edge 17 and/or beyond the base body surface 18 in relation to the fastening direction 49.
Aspect C5: Handheld work apparatus according to one of aspects C1 to C4,
   characterized in that the at least one abutment element 130 is fixed to the frame 7 or to the base body 11, in particular that the at least one abutment element 130 is made from the same materially as the frame 7 or the base body 11.
Aspect C6: Handheld work apparatus according to one of aspects C1 to C5,
   characterized in that a possible distance r between the sealing element 77 and the at least one abutment element 130, measured in the direction perpendicular to the fastening direction 49, is smaller than five times, in particular three times, in particular once the sealing element height h1.
Aspect C7: Handheld work apparatus according to one of aspects C1 to C6,
   characterized in that only one single fastening element 12 is provided for fastening the filter component 1 to the base body 11, in particular that the fastening element 12 is arranged spaced apart from an edge of the frame 7.
Aspect C8: Handheld work apparatus according to one of aspects C1 to C7,
   characterized in that at least two, in particular several abutment elements 130 are provided, which are spaced apart from each other in relation to the circulation direction 48.
Aspect D1: Filter component for filtering cooling air for a handheld work apparatus 2, wherein the filter component 1 is provided to form a part of an outer side 3 of the work apparatus 2 and to be mounted on a base body 11 of the work apparatus 2, wherein the filter component 1 comprises a gauge element 110 for aligning the work apparatus 2, in particular for aligning a tool 10 of the work apparatus 2,
   characterized in that the filter component 1 has a sealing element 77 for contact with the base body 11 of the handheld work apparatus 2 and for sealing between the filter component 1 and the base body 11, and that the gauge element 110 and the sealing element 77 are made from the same material.
Aspect D2: Filter component according to aspect D1,
   characterized in that the gauge element 110 and the sealing element 77 are designed to be monolithic with each other as a gauge and sealing element 111.
Aspect D3: Filter component according to aspect D1 or D2,
   characterized in that both the gauge element 110 as well as the sealing element 77 are made from a thermoplastic elastomer.
Aspect D4: Filter component according to one of aspects D1 to D3,
   characterized in that the filter component 1 has an inner side 14 facing towards the base body 11 in the installed position of the filter component 1 and an outer side 15 facing away from the base body 11 in the installed position of the filter component 1, that the filter component 1 has at least one through-flow opening 16, in particular at least two through-flow openings 16, more particularly four through-flow openings 16, that the at least one through-flow opening 16 penetrates the filter component completely from the inner side 14 to the outer side 15, and that the gauge and sealing element 111 extends through the at least one through-flow opening 16.
Aspect D5: Filter component according to one of aspects D1 to D4,
   characterized in that the filter component 1 has a frame 7, that the frame 7 has a duct 80 for receiving the sealing element 77 on the inner side 14 of the filter component 1, and that the frame 7 has a gauge element 114 for receiving the gauge element 110 on the outer side 15 of the filter component 1.
Aspect D6: Filter component according to aspects D4 and D5,
   characterized in that the at least one through-flow opening 16 connects the duct 80 and the gauge element duct 114 to each other.
Aspect D7: Filter component according to one of aspects D1 to D6,
   characterized in that the frame 7 and the gauge element 110 contrast in color.
Aspect D8: Filter component according to one of aspects D1 to D7,
   characterized in that a gauge element 110 is arranged on the outer side 15 of the filter component 1.
Aspect D9: Handheld work apparatus comprising a filter component 1 according to one of aspects D1 to D8.
Aspect D10: Handheld work apparatus having a filter component according to aspect D8,
   characterized in that the work apparatus 2 comprises a tool 10, that the tool 10 has a longitudinal extension, that the gauge element 110 has a piercing guide 112 and/or a felling guide 113, and that the piercing guide 112 extends substantially in the direction of the longitudinal extension in the installed position and/or that the felling guide 113 extends in the direction transverse, in particular perpendicular, to the direction of the longitudinal extension.
Aspect D11: Handheld work apparatus according to aspect D10,
   characterized in that the piercing guide 112 and the felling guide 113 are arranged in such a way that they appear separated from each other by concealing areas.
Aspect D12: Method for producing a filter component for filtering cooling air for a handheld work apparatus 2, wherein the filter component 1 is provided to form a part of an outer side 3 of the work apparatus 2 and to be mounted on a base body 11 of the work apparatus 2, wherein the filter component 1 comprises a gauge element 110 for aligning the work apparatus 2, in particular for aligning a tool 10 of the work apparatus 2,
   characterized in that the filter component 1 has a sealing element 77 for contact with the base body 11 of the handheld work apparatus 2 and for sealing between the filter component 1 and the base body 11, and that the gauge element 110 and the sealing element 77 are cast in a single casting step and thereby an, in particular monolithic, gauge and sealing element 111 is formed.

What is claimed is:

1. A handheld work apparatus, comprising
a filter component (1) configured to filter cooling air for the handheld work apparatus (2),
wherein the filter component (1) forms part of an outer side (3) of the handheld work apparatus (2),
wherein cooling air is directed through the filter component (1) in a through-flow direction (50) from an outside into an inner region (6) of the handheld work apparatus (2),
wherein the filter component (1) includes thick thread elements (4) and thin thread elements (5),
wherein the cooling air passes through both the thin thread elements (5) and the thick thread elements (4) to effect filtration of the cooling air,
wherein the thick thread elements (4) and the thin thread elements (5) are each strand-shaped,
wherein a diameter (d1) of the thick thread elements (4) is greater than a diameter (d2) of the thin thread elements (5), and
wherein the thick thread elements (4) support the thin thread elements (5).

2. The handheld work apparatus according to claim 1, wherein
the thick thread elements (4) are interwoven to form a supporting fabric (20) and the thin thread elements (5) are separately interwoven to form a filter fabric (30), or
the thick thread elements (4) and the thin thread elements (5) are interwoven together to form a single supporting filter fabric (40).

3. The handheld work apparatus according to claim 1, wherein
the thick thread elements (4) are interlaced to form a supporting fabric (20) and the thin thread elements (5) are separately interlaced to form a filter fabric (30), or
the thick thread elements (4) and the thin thread elements (5) are interlaced together to form a single supporting filter fabric (40).

4. The handheld work apparatus according to claim 1,
wherein the thick thread elements (4) form a supporting fabric (20), and the thin thread elements (5) form a filter fabric (30), and
wherein the filter fabric (30) is supported on the supporting fabric (20) during operation of the filter component (1).

5. The handheld work apparatus according to claim 1,
wherein the thick thread elements (4) form a supporting fabric (20), and the thin thread elements (5) form a filter fabric (30), and
wherein the filter fabric (30) is arranged in the handheld work apparatus (2) so that it forms a part of the outer side (3) of the handheld work apparatus (2) and
wherein the supporting fabric (20) is facing towards an inner region (6) of the handheld work apparatus (2).

6. The handheld work apparatus according to claim 1,
wherein the thick thread elements (4) form a supporting fabric (20), and the thin thread elements (5) form a filter fabric (30),
wherein the filter component comprises a further supporting fabric (60), and
wherein the filter fabric (30) is arranged between the supporting fabric (20) and the further supporting fabric (60).

7. The handheld work apparatus according to claim 1,
wherein the thick thread elements (4) form a supporting fabric (20), and the thin thread elements (5) form a filter fabric (30), and
wherein a supporting mesh size (a1) of the supporting fabric (20) is greater than a filter mesh size (a2) of the filter fabric (30).

8. The handheld work apparatus according to claim 1,
wherein the thick thread elements (4) and/or the thin thread elements (5) are made from metal.

9. The handheld work apparatus according to claim 1,
wherein the filter component (1) has at least two connecting ribs (8, 9),
wherein the at least two connecting ribs (8, 9) are arranged on the thin thread elements (5) and/or the thick thread elements (4) and are provided for arranging on the outer side of the handheld work apparatus.

10. A filter component (1) for filtering cooling air for a handheld work apparatus (2),
comprising:
a frame (7); and
a fabric (70),
wherein the filter component (1) is configured such that cooling air flows therethrough in a through-flow direction (50),
wherein the frame (7) holds edge regions of the fabric (70) on both sides with respect to the through-flow direction (50), and extends in a closed loop around the fabric (70),
wherein the fabric (70) has a through opening (74) extending completely through the fabric (70) in the through-flow direction (50) for passage of a pin (73) during production of the filter component (1), and
wherein the filter component (1) comprises a blocking element positioned such that cooling air is prevented from flowing through the filter component (1) in a region of the through opening (74).

11. The filter component according to claim 10,
wherein the through opening (74) is surrounded by material of the frame (7).

12. The filter component according to claim 10,
wherein the frame (7) comprises a circumferential frame (19) and a connecting structure (32),
wherein the circumferential frame (19) runs around an edge (78) of the fabric (70),
wherein the connecting structure (32) connects two opposing points of the circumferential frame (19) to each other, and
wherein the through opening (74) is arranged in the region of the connecting structure (32).

13. The filter component according to claim 10,
wherein the through opening (74) is closed with a closure element (76) made of elastomer.

14. A filter component for filtering cooling air for a handheld work apparatus (2),
wherein the filter component (1) is configured to form a part of an outer side (3) of the handheld work apparatus (2) and to be mounted on a base body (11) of the handheld work apparatus (2),
wherein the filter component (1) comprises a gauge element (110) for aligning the handheld work apparatus (2),
wherein the filter component (1) has a sealing element (77) for contact with the base body (11) of the handheld work apparatus (2) and for sealing between the filter component (1) and the base body (11), and
wherein the gauge element (110) and the sealing element (77) are made of the same material.

15. The filter component according to claim 14,
wherein the gauge element (110) and the sealing element (77) are integrally formed as a single gauge and sealing element (111).

16. The filter component according to claim 14,
wherein both the gauge element (110) and the sealing element (77) are formed of a thermoplastic elastomer.

17. The filter component according to claim 15,
wherein the filter component (1) includes an inner side (14) that faces the base body (11) in an installed position of the filter component (1) and an outer side (15) that faces away from the base body (11) in the installed position of the filter component (1),
wherein the filter component (1) includes at least one through-flow opening (16) extending completely from the inner side (14) to the outer side (15), and
wherein the single gauge and sealing element (111) extends through the at least one through-flow opening (16).

18. The filter component according to claim 14,
wherein the gauge element (110) is arranged on the outer side (15) of the filter component (1).

19. A handheld work apparatus, comprising:
the filter component according to claim 18; and
a tool (10),
wherein the tool (10) has a longitudinal extension,
wherein the gauge element (110) includes
a piercing guide (112) that extends substantially in the longitudinal extension of the tool (10), and/or
a felling guide (113) that extends transverse to the longitudinal extension of the tool (10).
